(19) United States
(12) Patent Application Publication
(10) Pub. No.: US 2023/0294293 A1
(43) Pub. Date: Sep. 21, 2023

(54) SYSTEM AND METHOD FOR TRACKING USER ACTIONS RESPONSIVE TO SERVING OF TAILORED ADVERTISING CONTENT TO A USER

(71) Applicant: ConversionRobots Inc., Los Angeles, CA (US)

(72) Inventors: Christopher Tosswill, Los Angeles, CA (US); Sam Brewczynski, Los Angeles, CA (US); Mark Weaver, Los Angeles, CA (US)

(21) Appl. No.: 18/202,799

(22) Filed: May 26, 2023

Related U.S. Application Data
(63) Continuation-in-part of application No. 17/574,341, filed on Jan. 12, 2022, now Pat. No. 11,587,275.
Application No. 17/574,341 is a continuation of application No. 17/026,126, filed on Sep. 18, 2020, now Pat. No. 11,257,267.
(60) Provisional application No. 63/346,241, filed on May 26, 2022.
(60) Provisional application No. 62/902,246, filed on Sep. 18, 2019.

(51) Int. Cl. B25J 11/00; G06T 11/60; G06F 40/109; G06V 30/32; G06V 30/413; G06V 10/82; G06V 10/764; G06V 10/44

(52) U.S. Cl. CPC B25J 11/00; G06T 11/60; B25J 11/0005; G06F 40/109; G06V 30/347; G06V 30/413; G06V 10/82; G06V 10/764; G06V 10/44

(57) ABSTRACT

One variation of a method includes, at a transceiver installed at a location: retrieving a device identifier of a device proximal the transceiver; rendering a QR code defining the device identifier and a location identifier associated with the location; in response to scanning of the QR code by a recipient via the device, triggering the device to navigate to a webpage including a prompt to enter a set of contact information; and linking the location identifier, the device identifier, and the set of contact information to a recipient profile. The method further includes: receiving a request for content associated with an advertising campaign for presenting to the recipient; selecting a subset of keywords, from a set of keywords defined for the advertising campaign, based on the location identifier; and generating a unique set of content based on the subset of keywords and the set of contact information.

### CROSS-REFERENCE TO RELATED APPLICATIONS

This application claims the benefit of U.S. Provisional Application No. 63/346,241, filed on 26 May 2022, which is incorporated in its entirety by this reference.

This application is also a continuation-in-part of U.S. patent application Ser. No. 17/574,341, filed on 12 Jan. 2022, which is a continuation of U.S. patent application Ser. No. 17/026,126, filed on 18 Sep. 2020, which claims the benefit of U.S. Provisional Application No. 62/902,246, filed on 18 Sep. 2019, each of which is incorporated in its entirety by this reference.

### TECHNICAL FIELD

This invention relates generally to the field of marketing and more specifically to a new and useful method for tracking user actions in the field of marketing.

### BRIEF DESCRIPTION OF THE FIGURES

FIGS. 1A, 1B, and C are flowchart representations of a method;

FIGS. 2A, 2B, and 2C are flowchart representations of one variation of the method; and

FIG. 3 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

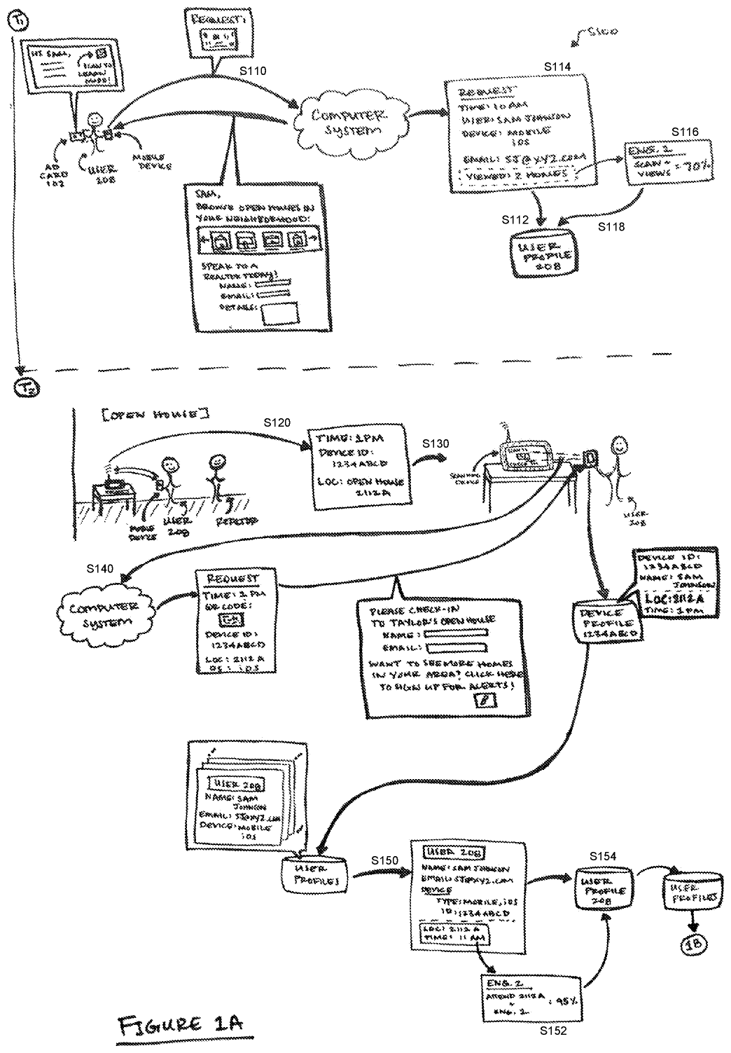

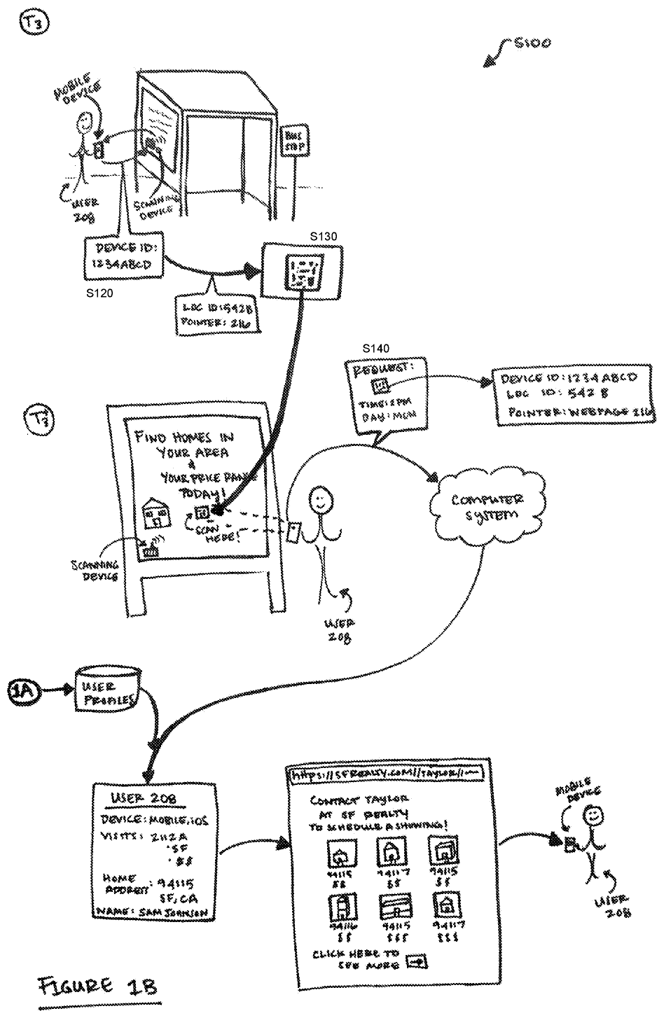

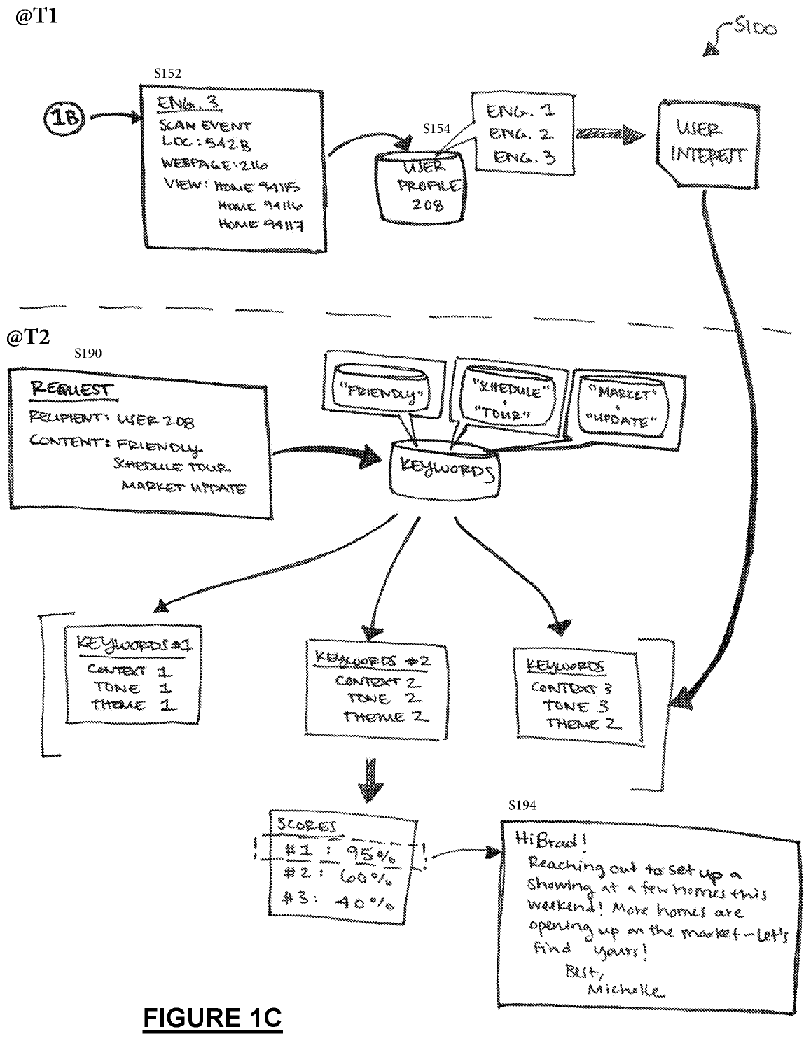

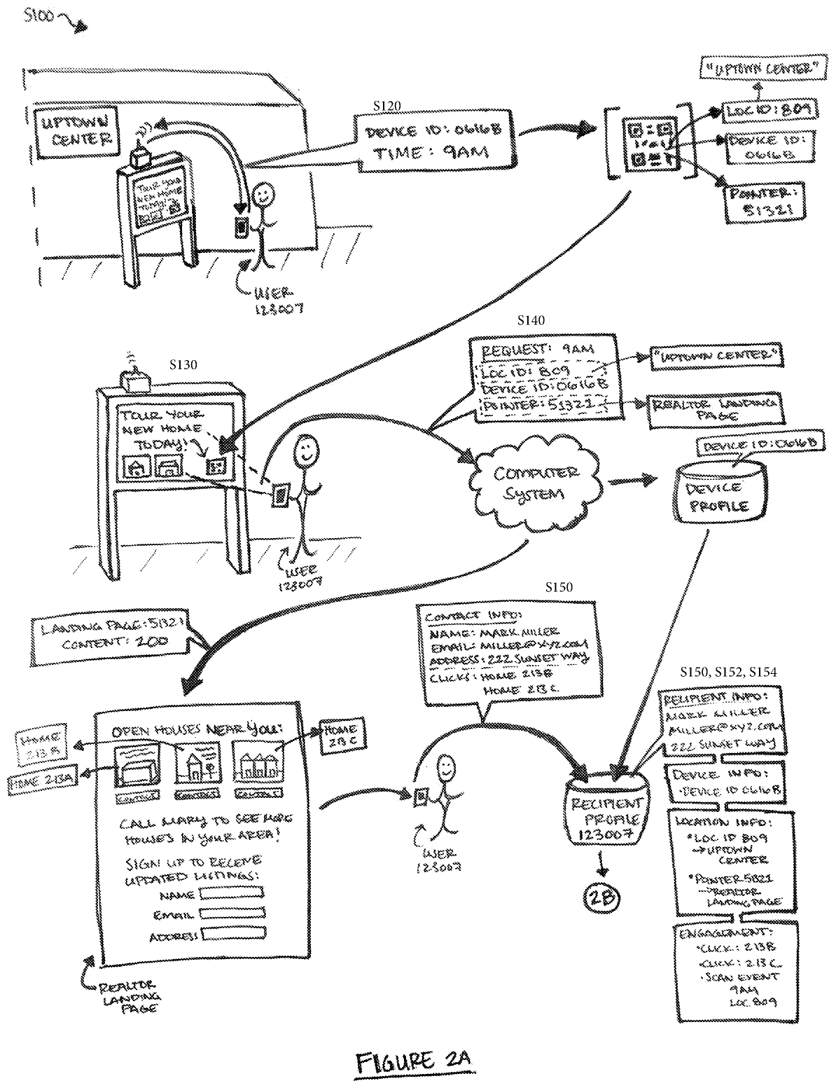

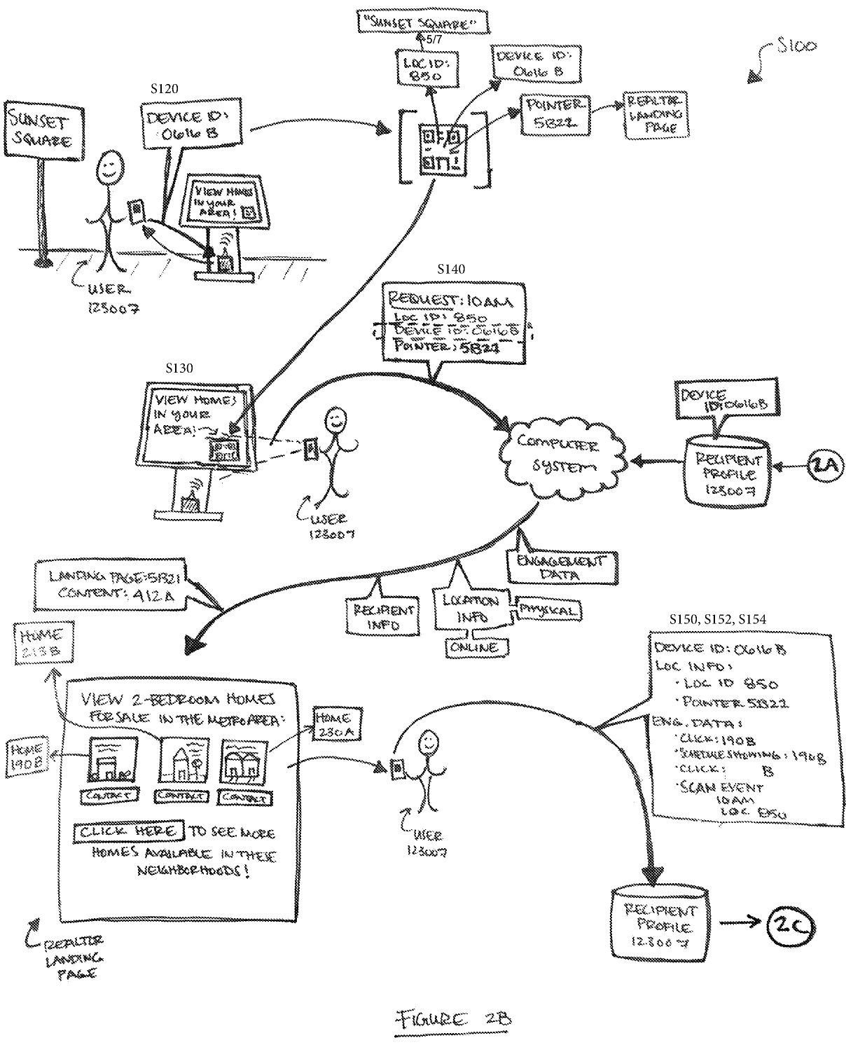

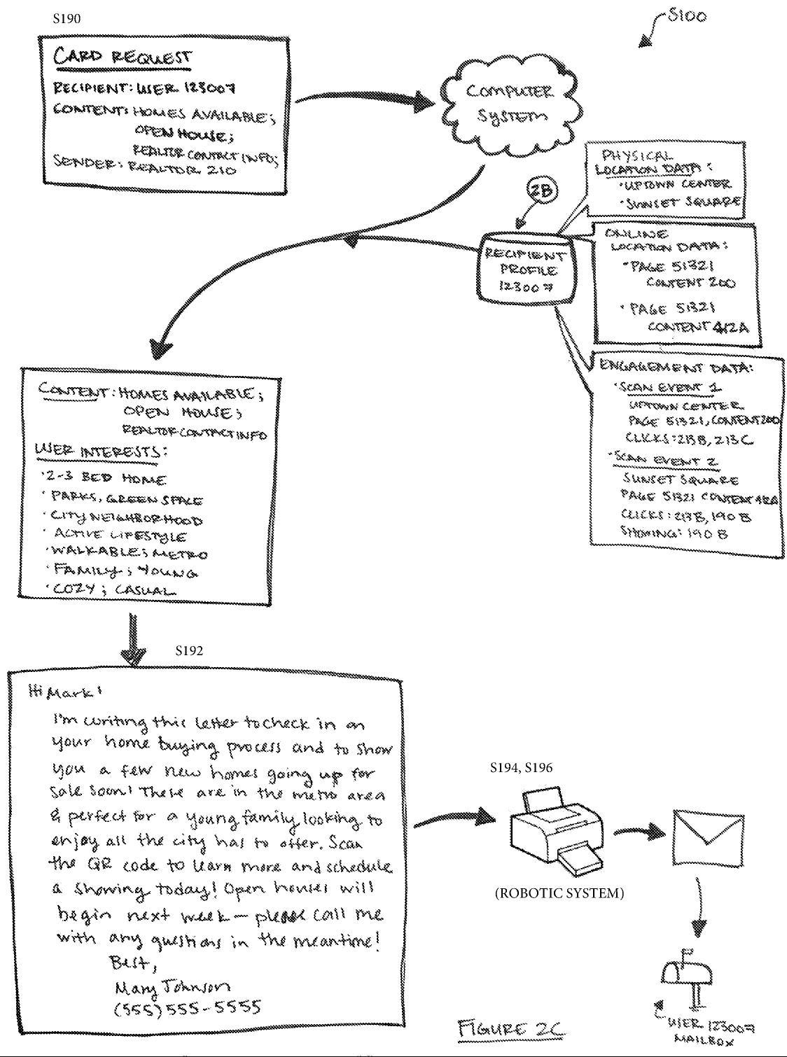

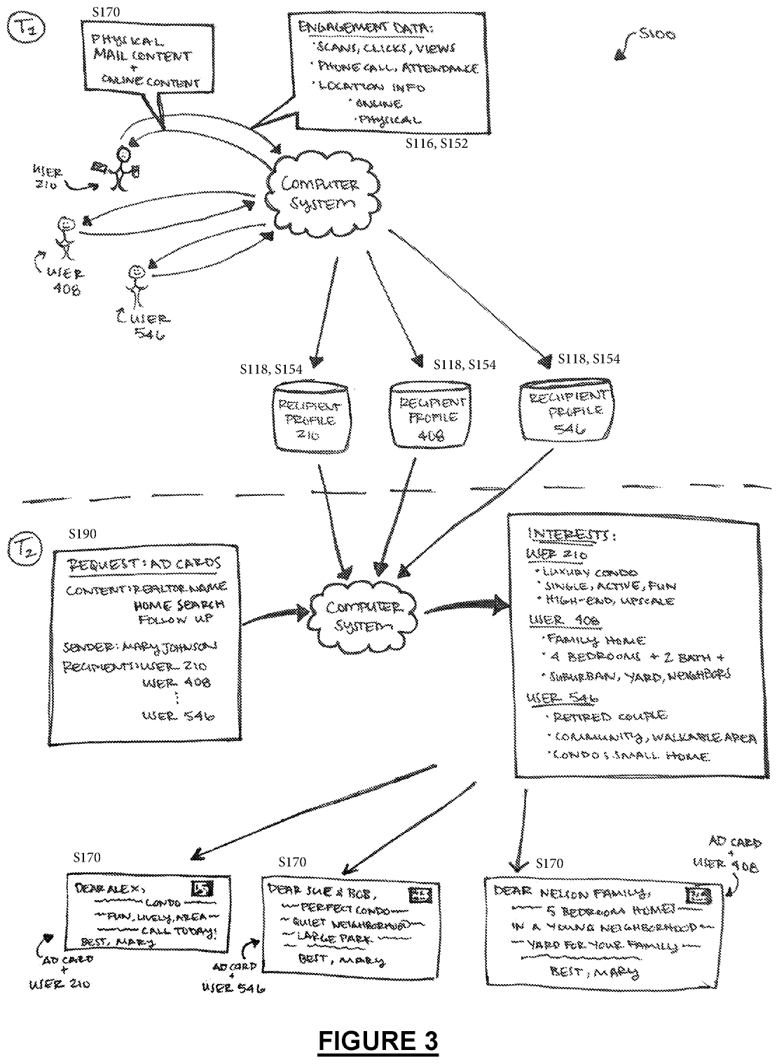

As shown in FIGS. 1A, 1B, and 2-4, a method S100 includes, during an initial time period: receiving a set of contact information of a user (or “recipient”), designated for receiving an advertisement card (e.g., a physical mailer) including advertising content specified by a sender of the advertisement card (e.g., a realtor, a car dealership, a restaurant owner, a retail store), from the sender; storing the set of contact information in a recipient profile, in a set of recipient profiles, generated for the user in Block S160; and linking a first QR code printed on the advertisement card to the recipient profile in Block S162. The method S100 further includes, during a first time period succeeding the initial time period, in response to a first scan event initiated by the user: receiving a first request—including the QR code—from a mobile device accessed by the user, the first request including the first QR code in Block S110; accessing a recipient profile, in a set of recipient profiles, based on the first QR code corresponding to the recipient profile in Block S112; updating a generic webpage—linked to the set of QR codes—to generate a customized instance of the webpage based on the set of contact information of the user in Block S180; triggering the mobile device to navigate to the customized instance of the webpage; accessing a set of device characteristics (e.g., a device operating system, a device type) of the device recorded at the webpage in Block S114; generating a first engagement metric based on the first scan event in Block S116; and storing the set of device information and the first engagement metric in the recipient profile in Block S118.

The method S100 further includes, during a second time period succeeding the first time period, at a transceiver installed in a venue (e.g., a venue hosting an event, a business, a store front) associated with the advertisement card: retrieving a device identifier (e.g., a MAC address, a Bluetooth ID) of a detected mobile device within a threshold distance of the transceiver in Block S120; and rendering a second QR code—including a location identifier and the device identifier encrypted within the second QR code—on a display of the transceiver in Block S130. During the second time period, the method S100 further includes, in response to a second scan event initiated by the user: receiving a second request—including the second QR code—from the detected mobile device in Block S140; triggering the detected mobile device to navigate to an electronic document (e.g., a webpage, a digital survey, a landing page within a native application) linked to the second QR code and including a prompt to enter a second set of contact information (e.g., name, email address, phone number) in the electronic document; retrieving the recipient profile based on a correlation between the first set of contact information and the second set of contact information; linking the device identifier to the recipient profile in Block S150; and generating a second engagement metric, in the set of engagement metrics, based on the second scan event in Block S152; and storing the second set of contact information and the second engagement metric in the recipient profile in Block S154.

One variation of the method S100 includes, during an initial time period, generating a first advertisement card including: a first set of advertising content—associated with a first sender of a first set of advertisement cards including the first advertisement card—and a first barcode, in a set of barcodes, printed on the first advertisement card and linked to a first recipient profile, in a set of recipient profiles, affiliated with a first recipient of the first advertisement card in Block S170. The method S100 further includes, during a first time period succeeding the initial time period, in response to a first scan event at a first computing device accessed by the first recipient: receiving a first request for advertising content from the first computing device, the first request specifying the first barcode in Block S110; triggering the first computing device to navigate to a first electronic document linked to the first barcode and including a second set of advertising content associated with the first advertisement card; deriving a first set of engagement metrics based on interactions of the first recipient with content presented to the first recipient within the first electronic document in Block S116; and, based on the first barcode, associating the first set of engagement metrics with the first recipient profile in Block S118.

In this variation, the method S100 further includes, during a second time period succeeding the initial time period, in response to a second scan event at the first computing device: receiving a second request for advertising content from the first computing device, the second request specifying a second barcode defining a first location identifier associated with a first location and a first set of device characteristics corresponding to the first computing device in Block S140; and, based on the first set of device characteristics, linking the first location identifier to the first recipient profile in Block S150. The method S100 further includes, during a third time period succeeding the first time period and the second time period: receiving a sender request for generation of a second advertisement card associated with the first sender and designating the first recipient in Block S190; accessing a set of keywords defined for advertising content affiliated with the first sender; predicting a first keyword score for a first subset of keywords, in the set of keywords, based on the first set of engagement metrics and the first location identifier, the first keyword score representing a propensity of the first recipient to engage with advertising content associated with the first subset of keywords; and, in response to the first keyword score exceeding a threshold score, automatically generating a third set of advertising content for printing on the second advertisement card based on the first subset of keywords in Block S192.

In one variation, the method S100 further includes: generating a first print file, in a set of print files, including instructions for printing of the second advertisement card including the third set of advertising content and a third barcode linked to the first recipient profile in Block S194; generating a second print file, in the set of print files, including instructions for printing of a fourth advertisement card including a fourth set of advertising content and a fourth barcode linked to a second recipient profile associated with a second recipient designated to receive the fourth advertisement card in Block S192; and transmitting the set of print files to a robotic system configured to print copies of print files to generate a first printed copy of the second advertisement card for mailing to the first recipient and a second printed copy of the fourth advertisement card for mailing to the second recipient in Block S196.

One variation of the method S100 includes, during an initial time period, generating a first advertisement card designating a first recipient and including a first set of advertising content associated with a first sender of the first advertisement card and a first barcode, in a set of barcodes, printed on the first advertisement card and associating the first barcode with a first recipient profile, in a set of recipient profiles, affiliated with the first recipient in Block S170. The method S100 further includes, during a first time period succeeding the initial time period, in response to a first scan event at a first computing device accessed by the first recipient: receiving a first request for advertising content from the first computing device and specifying the first barcode in Block S110; triggering the first computing device to navigate to a first electronic document linked to the first barcode and including a second set of advertising content associated with the first sender; deriving a first set of engagement metrics based on interactions of the first recipient with content presented to the first recipient within the first electronic document in Block S116; and, based on the first barcode, associating the first set of engagement metrics with the first recipient profile in Block S118. The method S100 further includes, during a second time period succeeding the initial time period, in response to a second scan event at the first computing device: receiving a second request for advertising content from the first computing device, the second request specifying a second barcode and a first set of device characteristics corresponding to the first computing device; accessing an identifier profile, in a set of identifier profiles, affiliated with the second barcode and specifying a first location linked to the second barcode in Block S140; and, based on the first set of device characteristics, associating the first location with the first recipient profile in Block S150.

In the preceding variation, the method S100 further includes, during a third time period succeeding the first time period and the second time period: receiving a sender request for generation of advertising content associated with the first sender and designating the first recipient in Block S190; accessing a set of keywords defined for advertising content affiliated with the first sender; predicting a keyword score for a first subset of keywords, in the set of keywords, based on the first set of engagement data and the first location, the keyword score representing a propensity of the first recipient to engage with advertising content associated with the first subset of keywords; and, in response to the keyword score exceeding a threshold score, automatically generating a third set of advertising content for printing on a second advertisement card designating the first recipient, based on the first subset of keywords in Block S192.

One variation of the method S100 includes, during an initial time period, generating a first advertisement card designating a first recipient and including a first set of advertising content associated with a first sender of the first advertisement card and a first barcode, in a set of identifiers, printed on the first advertisement card, and, associating the first barcode with a first recipient profile, in a set of recipient profiles, affiliated with the first recipient in Block S170. The method S100 further includes, during a first time period succeeding the initial time period, in response to a first scan event at a first computing device: receiving a set of scan characteristics corresponding to the first scan event and including the first barcode in Block S110; associating the first scan event with the first recipient based on the first barcode; deriving a first engagement metric representing user interactions with the first advertisement card based on the first scan event in Block S116; and linking the first engagement metric to the first recipient profile in Block S118. In this variation, the method S100 further includes, during a second time period succeeding the first time period, in response to a second scan event at the first computing device: receiving a set of scan characteristics corresponding to the second scan event and including a second barcode and the set of device characteristics in Block S140; associating the second scan event with the first recipient based on the set of device characteristics in Block S150; accessing an identifier profile, in a set of identifier profiles, affiliated with the second barcode and specifying a first location associated with the second barcode; based on the first engagement metric and the first location, generating a set of advertising content for presenting to the first recipient within a first webpage linked to the second barcode in Block S180; and triggering the first computing device to navigate to the first webpage for presentation of the first set of advertising content to the first recipient.

One variation of the method S100 includes, during a first time period, at a transceiver installed in a venue at a first location: retrieving a device identifier of a mobile device located within a threshold distance of the transceiver in Block S120; and rendering a first barcode within a display of the transceiver, the first barcode including a pointer to a first electronic document, a location identifier linked to the first location, and, the device identifier associated with the mobile device in Block S130. The method S100 further includes, in response to a first scan event initiated by the user: receiving a request from the mobile device, the request specifying the first barcode in Block S140; triggering the mobile device to navigate to the first electronic document based on the first pointer, the first electronic document including a prompt to enter a set of contact information for the first user; and, in response to receiving the set of contact information from the first user, linking the location identifier, the device identifier, and the first set of contact information to a first recipient profile, in a set of recipient profiles, associated with the first recipient in Block S150. In this variation, the method S100 further includes, during a second time period succeeding the first time period: receiving a sender request for generation of a first advertisement card associated with the first sender and designating the first recipient in Block S190; accessing a set of keywords defined for advertising content affiliated with the first sender; selecting a first subset of keywords, in the set of keywords, for generation of advertising content designating the first recipient based on the location identifier; and generating a first set of advertising content for printing on the second advertisement card based on the first subset of keywords and the first set of contact information in Block S192.

One variation of the method S100 includes, during a first time period, at a first transceiver installed in a venue at a first location: retrieving a device identifier of a mobile device located within a threshold distance of the transceiver in Block S120; and rendering a first barcode within a display installed at the first location, the first barcode defining a first pointer to a first electronic document, a first location identifier linked to the first location; and the device identifier associated with the mobile device in Block S130. The method S100 further includes, during the first time period, in response to a first scan event initiated by the recipient: receiving a request from the mobile device, the request specifying the first barcode in Block S140; triggering the mobile device to navigate to the first electronic document based on the first pointer, the first electronic document including a prompt to enter a set of contact information for the first recipient; and, in response to receiving the set of contact information from the first recipient, linking the first location identifier, the device identifier, and the first set of contact information to a first recipient profile, in a set of recipient profiles, associated with the first recipient in Block S150. In this variation, the method S100 further includes, during a second time period succeeding the first time period, at a second transceiver installed at a second location: retrieving the device identifier of the mobile device located within the threshold distance of the second transceiver in Block S120; and rendering a second barcode within a display installed at the second location, the second barcode defining a second pointer to a second electronic document, a second location identifier linked to the second location, and the device identifier in Block S130. The method S100 further includes, during the second time period, in response to a second scan event initiated by the first recipient, receiving a second request—specifying the second barcode—in Block S140, and, in response to the device identifier corresponding to the device identifier linked to the first recipient profile: generating a set of content for presenting to the first recipient within the second electronic document based on the first set of contact information, the first location identifier, and the second location identifier in Block S180; and, based on the second pointer, triggering the mobile device to navigate to the second electronic document loaded with the set of content.

### 2. Applications

Generally, Blocks of the method S100 can be executed by a computer system (e.g., a remote computer system, a remote server)—in cooperation with a transceiver installed at a particular location—to: retrieve a device identifier (e.g., a MAC address, a Bluetooth ID) of a mobile device detected proximal the transceiver; render a unique QR code—containing the device identifier and a pointer to an electronic document (e.g., a webpage, a landing page of a native application) including advertising content; link a scan event—triggered by the user scanning the unique QR code with the mobile device—to the device identifier, encrypted in the QR code, and to user data (e.g., name, email address, mailing address, phone number), device data (e.g., device operating system, device type), and/or engagement data (e.g., user interactions with content) recorded at the electronic document rendered on the user's mobile device; and, over time, serve customized advertising content—including promotions, deals, events, surveys, etc.—to this user based on data collected for this user, at this mobile device.

In particular, by encrypting the device identifier in the QR code rendered on the display of the transceiver, the computer system can automatically link this device identifier to the scan event, and therefore to information collected at the webpage (e.g., first-party data and/or information entered by the user). The transceiver and the computer system (hereinafter the “system”) can thus: aggregate a multitude of data—including a unique device identifier associated with the user's mobile device, contact information of the user, and/or first-party data (e.g., device information, engagement data) collected during rendering of the webpage on the user's mobile device—for a user; leverage this data to track interactions and/or actions executed by the user in the physical world, such as via detection of the device identifier at various locations (e.g., geographic locations, events, vendors) by transceivers installed at these locations, user scanning of QR codes at these locations, and/or user interactions with webpages linked to these QR codes; and tailor advertising content (e.g., printed and/or digital advertising content)—including ads, surveys, invitations, promotions, etc.—presented to the user (e.g., at the user's mobile device and/or on physical, digital ads) over time based on the multitude of data collected for this user and/or other users exhibiting similar characteristics.

In one implementation, the system can enable higher-resolution tracking of ad campaigns by enabling tracking of the user's actions—in the physical world—responsive to serving of advertising content to the user. In particular, the system can enable linking of an action executed by the user—such as attending an open house event, visiting a car dealership, participating in a promotion at a retail store, dining at a particular restaurant, etc.—to advertising content previously presented to this user (e.g., prior to execution of the action). For example, the system can retrieve a device identifier of a mobile device proximal a billboard—including a first transceiver affixed to the billboard—including an ad for a local realtor. The first transceiver can then render a QR code—tailored to the device identifier of the mobile device—on a digital display on the billboard. In response to the user scanning this QR code with her mobile device, the computer system can: trigger the user's mobile device to navigate to a webpage associated with the realtor and including a listing of open houses within a surrounding region; and store the device identifier, first-party data collected at the webpage, and any identifying information provided by the user at the webpage in a recipient profile generated for this user. Later, at an open house hosted by the realtor, a second transceiver installed in the open house can collect timestamped device identifiers of mobile devices detected at the open house. Then, in response to these timestamped device identifiers including the device identifier of the user, the computer system can confirm attendance of the user at the open house and link this engagement to viewing of the ad rendered on the billboard.

Over time, the system can continue tracking user actions and/or engagement with advertising content and selectively serve the user additional advertising content based on historical actions and/or engagement and/or characteristics of the user and/or the user's mobile device. In particular, the system can personalize any experience accessed by this user (e.g., via scanning of a QR code), at this mobile device, based on historical engagement data stored for this user and linked to the device identifier of the mobile device. Additionally, the system can leverage historical data collected for this user to personalize experiences accessed by other users—exhibiting characteristics (e.g., demographics, purchase preferences) similar to this user—based on historical engagement data stored for the user. Furthermore, the system can leverage information—such as including historical actions and/or engagement, user characteristics, device characteristics—stored in the recipient profile to personalize content and/or generate unique content for printing on advertisement cards mailed to this user.

In particular, in one implementation, the system can automatically generate custom content for presenting to a user (or “recipient”) based on information stored in the recipient profile. For example, the system can: track timeseries of location data—represented physical and/or online “locations” visited by the user—such as based on detection of the user's mobile device and/or scanning of QR codes via the mobile device at these locations; derive engagement data or metrics—representing user interest or engagement with content presented to the user—for each scan event initiated by the user; and, based on these timeseries location data, engagement data, and characteristics of content presented to the user, derive an interest model representing user interest in various types of content, such as characterized by a particular theme, a particular set of context, a particular tone, etc. Then, based on this interest model and/or a set of parameters defined for an advertising opportunity (e.g., an ad card, a webpage), the system can generate unique content—such as for printing on an ad card mailed to the user's home and/or rendering within a webpage viewed on the user's mobile device—predicted to yield high user interest or engagement when presented to this particular user.

Generally, the system is described below as executing Blocks of the method S100 to selectively serve content to a recipient responsive to scanning of a QR code (i.e., a two-dimensional matrix barcode) by a mobile device accessed by the recipient. However, the system can execute Blocks of the method S100 to selectively serve content to a recipient responsive to scanning of any other type of scannable identifier.

### 3. Physical Advertisement Card: Unique Identifier

The computer system can generate a unique identifier (e.g., QR code), associated with a target recipient, for placement on an advertisement card, associated with an advertising campaign, assigned to the target recipient. This identifier can also include a pointer to an electronic document (e.g., a webpage, a PDF file, a landing page within a native application) associated with the advertisement card.

In one implementation, as described in U.S. patent application Ser. No. 17/949,098, filed on 20 Sep. 2022, which is incorporated in its entirety by this reference, during a setup period (e.g., preceding a first scan event), the computer system can generate an identifier, for placement on an advertisement card, including: a pointer to an electronic document associated with an advertising campaign; and a recipient code (e.g., a randomly generated text string) linked to the target recipient of the advertisement card, thereby linking the advertisement card and identifier to the target recipient. The computer system can then store this identifier—including the recipient code—in a recipient profile, in a set of recipient profiles, associated with the target recipient. The computer system and/or sender of the advertisement card can then: append the advertisement card with the identifier; and generate the advertisement card for delivery to the target recipient via physical mailing.

Later, during a live period succeeding the setup period, in response to a first scan event (e.g., the target recipient scanning the identifier via mobile phone), the computer system can: receive a query—including the recipient code and the pointer to the electronic document—from a computing device (e.g., a mobile device) accessed by the target recipient; access the set of recipient profiles; and identify the target recipient based on the recipient code contained in both the query and the recipient profile. The computer system can then: leverage identifying information (e.g., name, address, gender, age) contained in the recipient profile and the pointer to the electronic document to generate a customized instance of the electronic document; and trigger the computing device to navigate to this customized instance of the electronic document.

Alternatively, in another implementation, during the setup period, the computer system can generate an identifier including: a pointer to the electronic document associated with the advertisement card; and an encrypted recipient code (e.g., an encrypted name of the target recipient) linked to the target recipient and including a set of recipient characteristics associated with the target recipient (e.g., identifying information for the target recipient of the advertisement card). The computer system and/or sender of the advertisement card can then: append the advertisement card with the identifier; and deliver (e.g., via physical mail) the advertisement card to the target recipient.

Later, during the live period, in response to a first scan event (e.g., the target recipient scanning the identifier), the computer system can: receive a query—including the encrypted recipient code and the pointer to the electronic document—from a computing device accessed by the target recipient; decrypt the encrypted recipient code to access the set of recipient characteristics associated with the target recipient (e.g., identifying information for the target recipient); identify the target recipient based on the decrypted recipient code; generate a customized instance of the electronic document for the target recipient based on the pointer and identifying information contained in the recipient code of the identifier; and trigger the computing device to navigate to this customized instance of the electronic document.

Thus, in this implementation, by encoding identifying information of the target recipient directly within the identifier (e.g., QR code), the computer system can read this identifying information directly from the identifier to identify the target recipient—without accessing an externally-stored identifier “key” (e.g., the set of recipient profiles)—thereby: minimizing latency to generate the customized instance of the electronic document and/or direct the target recipient to this customized instance of the electronic document; and increasing a likelihood that the target recipient will engage with content at the customized instance of the electronic document.

Generally, Blocks of the method S100 can be executed by the computer system in cooperation with a robotic system (e.g., a set of printers and/or optical readers) to generate a set of ad mailers—including a set of advertisement cards and/or a set of envelopes configured to receive and retain the set of advertisement cards—for a print order received from a particular sender, each ad mailer, in the set of ad mailers, linked to a particular recipient in a set of recipients specified by the print order. In particular, the computer system can selectively distribute print files (e.g., vector images) containing instructions for printing content on an advertisement card and/or envelope in order to coordinate assembly of a set of ad mailers—each ad mailer customized for a particular recipient—for a particular print order.

### 3.1 Example: Physical Advertisement Card+Unique QR Code

In one example, a realtor may send a set of advertisement cards to potential customers (e.g., potential homebuyers) in a particular region. During a setup period, the computer system can receive content from the realtor—such as via a sender portal accessed within a native application executing on her computing device—for generating the set of advertisement cards, including: advertising content—such as a static advertisement (e.g., images of homes in a particular area) and/or a call to action (“Schedule a showing today!”)—for placement on the set of advertisement cards; a text string (e.g., a block of text containing general information about the realtor's business and/or homes advertised); and contact information (e.g., name, address, phone number, email address) for a set of customers (i.e., target recipients) to whom the realtor plans to send the set of advertisement cards. The computer system can then generate a primary advertisement card including advertising content and the text string received from the realtor.

Then, for a first customer, in the set of customers, the computer system can: generate a copy of the primary advertisement card; access a set of contact information—including a name and an address—associated with the first customer; input the name of the first customer at a beginning of the copy of the primary advertisement card; and generate a unique QR code associated with the first customer and linked to a webpage associated with the primary advertisement card. In particular, the QR code can include the set of contact information and a pointer to the webpage encoded (e.g., encrypted) within the QR code, such that when the customer later scans this unique QR code (e.g., with her mobile device), the computer system can decrypt the QR code to: read the set of contact information and therefore identify the customer corresponding to the unique QR code; and read the pointer to direct the first customer (or “recipient”) to the webpage.

The computer system can then append the copy of the primary advertisement card with the unique QR code, associated with the first customer, to generate a first advertisement card. The computer system can then repeat this process for each customer, in the set of customers, to generate the set of advertisement cards (e.g., copies of the primary advertisement card), each advertisement card, in the set of advertisement cards, linked to a particular customer, in the set of customers. The computer system can then trigger the robotic system to print the set of advertisement cards—each advertisement card, in the set of advertisement cards, addressed to a customer, in the set of customers, and including a unique QR code associated with that customer—for delivery to the set of customers (e.g., via physical mailing). Alternatively, the realtor may manually print the set of advertisement cards and deliver these advertisement cards to her customers.

Later, during a live period succeeding the setup period, the first customer may receive the first advertisement card in her mailbox. If the first customer is interested in contents of the first advertisement card, she may scan the QR code via her mobile device to access additional information related to the first advertisement card. Then, in response to the first customer scanning the QR code (or “the first scan event”), the computer system can: receive a customer query including the QR code; decrypt the QR code associated with the first customer (e.g., target recipient); and access a set of recipient characteristics—including the name and the set of contact information associated with the first customer (e.g., address of the first customer) and/or the pointer to the webpage associated with the advertisement card—contained in the first recipient profile. The computer system can thus automatically associate the first scan event—corresponding to scanning of the QR code by the first customer via her mobile device—with the first customer based on identifying information contained in the QR code printed on the first advertisement card.

### 3.2 Physical Advertisement Card: Robotic Printer System

In one implementation, the computer system can interface with a robotic system including: a robotic printer (e.g., a single point printer) configured to receive print files from the computer system and manipulate a writing implement (e.g., a pen) on a writing surface (e.g., an advertisement card, an envelope) to generate “handwritten” documents according to the print files; and a laser printer configured to receive print files from the computer system and laser print copies of the received print files accordingly. In this implementation, the robotic system can also include a set of optical readers configured to scan card identifiers (e.g., 2D-matrix barcodes) printed on the set of advertisement cards and/or the set of envelopes. The computer system can then access these identifiers scanned by the set of optical readers to retrieve and/or assign print files—each print file linked to a particular recipient in the set of recipients specified by the print order—for returning to the set of printers for printing on the set of advertisement cards and/or the set of envelopes.

The system—such as the computer system in combination with the robotic system—can therefore assemble an ad mailer for a particular recipient that includes an advertisement card (e.g., a postcard, a letter, a flyer)—and/or an envelope configured to be loaded with the advertisement card for mailing to the recipient—tailored to this particular recipient.

### 4. Physical Location Detection: Transceiver+QR Code

The system can include a transceiver configured to retrieve a device identifier of a mobile device detected proximal the transceiver for transmitting (e.g., directly and/or via the mobile device) to the remote computer system. The transceiver can include: a housing; an antenna configured to enable 2-way communication (e.g., transmission and receiving of communications) between the transceiver and a set of mobile devices (e.g., Bluetooth-enabled mobile devices) proximal (e.g., within the threshold distance of) the transceiver; a device-detection module configured to retrieve a set of device identifiers (e.g., a MAC address, a Bluetooth ID) of a mobile device located proximal the transceiver; a power supply (e.g., a battery); and a display (e.g., an LED display) arranged on and/or coupled to the housing and configured to render a QR code (e.g., a static or dynamic QR code). In one variation, the transceiver can be installed proximal a digital rendering and/or printed copy of a QR code (e.g., a static QR code). In this variation, the transceiver can therefore exclude the display.

In one implementation, the transceiver can include an ID reader (e.g., an RFID reader, an NFC reader) configured to retrieve a device identifier of a mobile device of a user in response to the user aligning the mobile device with the ID reader accordingly. Alternatively, in another implementation, the transceiver can include a Bluetooth scanner configured to: automatically detect presence of the mobile device (e.g., a Bluetooth-compatible device) of the user within a threshold distance of the transceiver; and automatically retrieve the device identifier of the mobile device in response to detecting presence of the mobile device.

### 4.1 Dynamic QR Codes

In one implementation, the transceiver can be configured to render a (dynamic QR code—tailored to a particular mobile device detected by the transceiver—on a display of the transceiver. In particular, the system can be configured to selectively modify this dynamic QR code, such that each instance of this dynamic QR code is unique to each other instance of the dynamic QR code rendered on the display and contains identifying information for the particular mobile device detected at the transceiver.

For example, in preparation for a vehicle showcase (e.g., a luxury vehicle showcase, a classic car showcase), a coordinator (e.g., an event coordinator) associated with the showcase may locate a transceiver in a lobby of a facility hosting the showcase. In this example, the transceiver can be configured to render a dynamic QR code—including an event identifier associated with the showcase and a pointer to a webpage associated with the showcase—on a display of the transceiver. Further, the dynamic QR code can define a modifiable region configured to receive and render a new (encrypted) device identifier—such as in replacement of a previous (encrypted) device identifier—responsive to detection of a mobile device proximal the transceiver. Therefore, at a first time during the showcase, in response to detecting (e.g., via Bluetooth) a first mobile device of a first user, proximal the transceiver, the transceiver can: retrieve a first device identifier (e.g., a MAC address, a Bluetooth ID) of the first mobile device; encrypt the first device identifier (e.g., according to an encryption protocol) to generate a first encrypted device identifier representing the first device identifier; insert the first encrypted device identifier into the modifiable region of the dynamic QR code to generate a first unique QR code; and render the first unique QR code—containing the first encrypted device identifier, the event identifier, and the pointer to the webpage—on the display of the transceiver. Then, in response to the first user scanning this first unique QR code, the computer system (e.g., a remote server) can receive a first request—initiated by the first mobile device—including this first unique QR code and thereby including the first encrypted device identifier. The system can thus link interactions of this first user at the webpage—including first-party data collected at the webpage and/or information (e.g., identifying information) supplied by the first user at the webpage—to the first device identifier.

Later, at a second time, in response to detecting a second mobile device of a second user proximal the transceiver, the transceiver can: retrieve a second device identifier of the second mobile device; encrypt the second device identifier to generate a second encrypted device identifier representing the second device identifier; insert the second encrypted device identifier into the modifiable region of the dynamic QR code to generate a second unique QR code; and render the second unique QR code—containing the second encrypted device identifier, the event identifier, and the pointer to the webpage—on the display of the transceiver. Then, in response to the second user scanning this second unique QR code, the computer system can receive a second request—initiated by the second mobile device—including this second unique QR code and thereby including the second encrypted device identifier. The system can thus link interactions of this second user at the webpage—including first-party data collected at the webpage and/or additional information (e.g., identifying information) supplied by the second user at the webpage—to the second device identifier. The system can therefore distinguish between the first user interacting with the webpage rendered on the first mobile device at the first time and the second user interacting with the webpage rendered on the second mobile device at the second time. Further, the system can store these device identifies for the first and second mobile devices, such that the system can instantly identify the first and second user in response to detecting the first and/or second device identifier at this transceiver and/or at a second transceiver (e.g., installed at the showcase and/or installed in a different location).

Therefore, by rendering a dynamic QR code—configured to be modified over time to include identifying information (i.e., a device identifier) for a particular mobile device detected at (e.g., proximal, contacting) the transceiver—the system can enable transmitting of this device-identifying information directly in the request transmitted by the user's mobile device, thereby enabling direct linkage between engagement data collected for the user scanning this dynamic QR code with the device identifier(s) of this mobile device. Further, by leveraging transmitting of the request by the user's mobile device, the system can enable retrieval of the device identifier(s) by the computer system without any direct communication—such as via Wi-Fi and/or physical connection—between the transceiver and the computer system, thereby reducing overall power consumption and minimizing downtime of the transceiver (e.g., due to charging) and/or required user maintenance.

### 4.2 State QR Codes

in one implementation, the system can be configured to associate scanning of a static QR code (e.g., a printed, static QR code and/or a digital, static QR code)—by a mobile device accessed by a user—with a device identifier, of the mobile device, uploaded to the computer system from the transceiver. In particular, in this implementation, the transceiver can record timestamped instances of mobile devices detected at the transceiver—each mobile device represented by one or more device identifiers—and transmit this timestamped data to the computer system. The computer system can then link these timestamped device identifiers to timestamped visits to the webpage, by users scanning this static QR code with their mobile devices, to associate each timestamped visit to the webpage—or each timestamped request transmitted by a mobile device of a user—to a timestamped device identifier recorded by the transceiver.

In this implementation, the transceiver can be configured to transmit data (e.g., device identifiers), collected by the transceiver, to the computer system in (near) real-time via Wi-Fi. Additionally and/or alternatively, in this implementation, the transceiver can be configured to store data locally—such as on a memory chip (e.g., a SIM card) integrated within the transceiver—for transmission to the computer system retroactively (e.g., at a particular frequency), such as via direct, physical connection of the transceiver and/or memory chip to the computer system and/or via Wi-Fi.

For example, a printed billboard—installed along a sidewalk—can include a static QR code (e.g., a printed QR code) rendered on the printed billboard. This static QR code can be configured to include: a location identifier associated with a location of the billboard; an advertiser identifier of an advertiser associated with advertising content rendered on the printed billboard; and/or a pointer to a webpage associated with advertising content rendered on the printed billboard and/or the advertiser. In this example, the transceiver can be configured to: record a timeseries of device identifiers of mobile devices—detected within a threshold distance of the transceiver—to a local memory (e.g., a SIM card) of the transceiver; and offload this timeseries of device identifiers from the local memory to the computer system at a target frequency (e.g., once-per-hour, once-per-day, once-per-week).

In this example, at a first time during a first time period of a target duration (e.g., defined by the target frequency), the transceiver can: detect a first mobile device within a threshold distance of the transceiver; retrieve a first time value (e.g., a timestamp) corresponding to the first time; retrieve a first device identifier of the first mobile device; and record a first data packet, in a set of data packets, containing the first time value and the first device identifier. Then, in response to the first user scanning the static QR code via the first mobile device, the computer system can receive a first request including the static QR code—including the location identifier, the advertiser identifier, and/or the pointer—and a first request time value associated with transmission of the first request; and access a first set of engagement data for the first user interacting with content on the webpage, a first set of user information (e.g., identifying information)—such as a first name, a first email address, and/or a first phone number—supplied by the first user at the webpage, and/or a first set of device information (e.g., contained in first-party data)—such as a first device type and/or a first device operating system—recorded at the webpage.

Then, in the preceding example, at a second time during the first time period, the transceiver can: detect a second mobile device and a third mobile device within the threshold distance of the transceiver; retrieve a second time value corresponding to the second time; retrieve a second device identifier of the second mobile device and a third device identifier of the third mobile device; and record a second data packet, in the set of data packets, containing the second time value, the second device identifier, and the third device identifier. In response to the second user scanning the static QR code via the second mobile device, the computer system can: receive a second request including the static QR code and a second request time value associated with transmission of the second request; and access a second set of engagement data for the second user interacting with content on the webpage, a second set user information—such as a second name, a second email address, and/or a second phone number—supplied by the second user at the webpage, and a second set, of device information—such as a second device type and/or a second device operating system—recorded at the webpage.

Then, in response to expiration of the target duration, the transceiver can transmit the set of data packets to the computer system (e.g., local or remote server), such as via a wireless connection. The computer system can then pair the first request with the first data packet—such as based on a correlation between the first time value and the first request time value—thereby linking the first device identifier to the first set of engagement data, the first set of user information, and/or the first set of device information. The computer system can then pair the second request with the second data packet,—such as based on a correlation between the second time value and the second request time value. The system can therefore predict either the second or third mobile device—represented by the second and third device identifiers—as corresponding to the second request including the second set of engagement data, the second set of user information, and/or the second set of device information. However, at a later time, in response to detecting the second mobile device—absent detection of the third mobile device—proximal a second transceiver (e.g., installed at the printed billboard and/or at a different location), and in response to the user scanning a QR code rendered at this transceiver,—thereby generating a third request—the system can retroactively pair the second request to the second mobile device of the second user based on the second device identifier, user information, and/or device information contained in both the second and third requests.

The system can therefore retroactively link these timestamped requests or “scan events”—initiated by a particular mobile device of a particular user—to a timestamped device identifier recorded by the transceiver. Further, the system can leverage timestamped requests and timestamped device identifiers collected over time—at one or more transceivers installed at one or more locations—to isolate a particular device identifier (e.g., when more than one mobile device is detected proximal the transceiver during a scan event) associated with a request, received by the computer system, based on matching of identifying information (e.g., first-party data and/or information supplied by the user) collected at the webpage.

### 5. User Onboarding: Recipient Profile

Generally, the system can generate a recipient profile for a new user (or “recipient”)—such as a recipient of physical advertisement cards mailed by a particular sender and/or a recipient of online content rendered within the user's mobile device (e.g., responsive to a scan event)—responsive to receiving identification of this new user. The system can then store user data—such as including a set of contact information for the user (e.g., name, phone number, email address, mailing address) and/or a set of user characteristics (e.g., age, gender, income, household size, home location, demographics)—in the recipient profile generated for this user. For example, the system can: receive a set of contact information—including a name and a mailing address of a recipient—from a particular sender of advertisement cards in preparation for generation and/or mailing of an advertisement card for mailing to this recipient; generate a recipient profile for this recipient; and populate this recipient profile with set of contact information corresponding to the recipient.

Over time, the system can update the recipient profile based on new information received and/or derived for this particular recipient. In particular, in one example, the system can append the recipient profile with: a set of device characteristics corresponding to a mobile device of the recipient, such as a device identifier (e.g., a Bluetooth ID, a MAC address), a device operating system (e.g., android, iOS), a local network associated with a mobile device, etc.; additional contact information (e.g., provided by the recipient and/or the sender) for the recipient, such as a phone number, an email address, etc.; a set of location data representing online and/or physical locations visited by the recipient; a set of engagement data representing user interactions with content delivered—such as via physical mail and/or digitally rendered within the recipient's mobile device—to this recipient, as further described below; etc.

### 5.1 User Onboarding: Physical Advertisement Cards

In one implementation, the system can generate a recipient profile for a particular user responsive to a sender (e.g., an advertisement card sender) specifying this particular user as a target recipient of an advertisement card. In particular, the system can: receive contact information (e.g., name, mailing address, phone number, email address) for a group of users to whom the sender plans to send a set of advertisement cards; and, for each user, in the group of users, populate a recipient profile, in a set of recipient profiles, with contact information of this user. The system can then link each advertisement card to a particular recipient profile, in the set of recipient profiles, based on a unique QR code rendered on the advertisement card.

For example, a realtor may specify a group of users to whom the realtor plans to send a set of advertisement cards containing advertising content associated with the realtor. In particular, in this example, the system can; receive information from the realtor—such as via a portal accessed within a native application executing on a computing device accessed by the realtor—for generating the set of advertisement cards including: advertising content—such as a static ad (e.g., images of homes in a particular area) and/or a call to action (“Schedule a showing today!”)—for placement on the set of advertisement cards; a text string (e.g., a block of text containing general information about the realtor's business and/or homes advertised); and contact information (e.g., name, address, phone number, email address) for the group of users (i.e., mail recipients) to whom the realtor plans to send the set of advertisement cards. Then, for a particular advertisement card, in the set of advertisement cards, the system can: generate a QR code, in a set of QR codes, for printing on the advertisement card, such that each QR code, in the set of QR codes, is unique to each other QR code, in the set of QR codes, and includes a pointer to a webpage specified by the realtor; select a particular user, in the set of users, for assigning to the advertisement card; access a set of contact information—such as a first and last name, a mailing address, an email address, and/or a phone number—provided by the realtor and corresponding to this particular user; and link this set of contact information to the QR code printed on this advertisement card, such as by storing the QR code and the set of contact information in a recipient profile associated with the user.

The system can therefore link this particular QR code—printed on the advertisement card addressed to this particular user (i.e., advertisement card recipient)—to the recipient profile generated for this particular user and populated with basic information for this user (e.g., contact information) provided by the sender (e.g., realtor).

### 5.1.1 Initial User Engagement: Ad Mail Received

In one implementation, the system can update the recipient profile associated with the user in response to receiving confirmation of the user scanning the unique QR code—via a mobile device (e.g., a smartphone, a tablet) accessed by the user—printed on the advertisement card mailed to the user. The system can thus link this scan event—initiated by the user scanning the unique QR code on the advertisement card—to the recipient profile associated with this user based on identification of the unique QR code.

For example, during a first time period succeeding generating and/or mailing of the advertisement card during an initial time period, the user may receive the advertisement card—sent from a realtor and containing advertising content related to this realtor—in her mailbox. If the user is interested in contents of the advertisement card, the user may scan the unique QR code—rendered on the advertisement card and linked to the set of contact information for this particular user—with her mobile device (e.g., by capturing an image of the QR code with her mobile device) to access a webpage including additional information related to the advertisement card, based on the pointer contained in the QR code.

Then, in response to the user scanning this unique QR code, the system can: at a first time within the first time period, receive a request—such as from a remote server executing the webpage on the user's mobile device—including the unique QR code and/or a set of identifiers encrypted in the unique QR code; access the set of recipient profiles generated for the group of users specified by the realtor, and access the set of contact information for this user—stored in the recipient profile associated with this particular user—based on the unique QR code and/or the set of identifiers; record a first time value corresponding to the first time and linked to initial engagement of the user with the advertisement card; leverage the set of contact information of the user to generate a customized instance of the webpage that is tailored to this user (e.g. including a salutation addressed to the first name if the user and/or including advertising content related to homes for sale proximal a mailing address of the user); and trigger the mobile device of the user to navigate to this customized instance of the webpage, such as via transmitting of a URL—for the customized instance of the webpage—to the remote server. Further, the system can: generate an initial engagement data packet, in a set of engagement data packets, for the user based on the initial time value and an initial action executed by the user—such as scanning of the unique QR code printed on the advertisement card—representing engagement of the user with contents of the advertisement card; and link this initial engagement to the recipient profile for this user. The system can also retrieve a set of engagement data—representing user interactions (e.g., clicks, scrolls, views, purchases, data entry) with content viewed by the user at the webpage—recorded at the webpage for including in the initial engagement data packet.

Further, in this implementation, in response to receiving a request, the system can access request characteristics (e.g., device and/or user information)—including a time of day, a date, a geographic location of the user and/or the user's mobile device, a device type, a device operating system, webpage metadata, and/or user demographics—associated with the scan event. The system can then leverage this information to update the recipient profile for this user based on these characteristics, thereby enabling aggregation of both initial information (e.g., contact information) received for this user (e.g., by the advertisement card sender)—such as a name, mailing address, phone number, and/or email address—and device-identifying information—such as the device type and/or the device operating system—at the recipient profile.

### 5.1.2 Attribution: Action Linked to Ad Mail

In one implementation, the system can attribute actions executed by the user—such as attending an in-person event (e.g., a sale, an open-house, a car show, a fashion event, a restaurant expo) and/or visiting a particular location (e.g., a restaurant, a store, a car dealership)—to a particular advertisement card sent to this user. Further, in this implementation, the system can leverage detection of the user's mobile device at this particular event and/or location to retrieve additional device-identifying information for this user's mobile device and therefore update the recipient profile of this user accordingly.

For example, the user may at tend an open house event—such as advertised in an advertisement card sent by a realtor and previously received by the user advertised on the customized instance of the webpage, and/or suggested to the user by the realtor during communication (e.g., via a chat window rendered within the customized instance of the webpage, via voice call, via email, via text message) between the user and the realtor initiated responsive to the user scanning the unique QR code printed on the advertisement card—hosted by the realtor. Prior to initiation of the open house event, the realtor—and/or a different user associated with the open house event—may install a transceiver within the home in which the open house event is hosted, such as near an entrance of the home and/or on a counter or table within the home. The transceiver can be configured to: detect a mobile device (e.g., Bluetooth-capable mobile devices)—such as a smartphone, a tablet, and/or a smartwatch—within a threshold distance (e.g., five feet, ten feet, twenty feet) of the transceiver; retrieve a device identifier (e.g., a MAC address) associated with this mobile device; and render a unique QR code—generated for this particular mobile device—based on the device identifier.

Then, during the open house event, the transceiver can: detect the mobile device of the user within the threshold distance of the transceiver; and retrieve a device identifier (e.g., a MAC address) of the mobile device. The system can then generate a unique QR code including: the device identifier (e.g., encrypted within the unique QR code); an event identifier associated with the open-house event; and a pointer to a webpage including a prompt to “check-in” at the open house by supplying contact information. The system can then trigger rendering of the unique QR code on the display of the transceiver. The user may then scan this unique QR code to access the webpage, enter her contact information—including her first and last name, email address, and/or mobile phone number—to “check-in” at the open house.

In particular, upon scanning of the QR code by the user—via her mobile device—the computer system can: receive a request—from the users mobile device—including the device identifier (e.g., the MAC address of the mobile device), the event identifier, and the pointer. The computer system can also receive a first time, a first date, additional identifying information of the user's mobile device—such as a device operating system, a type of device, etc.—in this request. Then, in response to the user entering her contact information at the webpage—rendered on a display of her mobile device—the computer system can: receive this contact information supplied by the user at the webpage; access the set of recipient profiles; identify the recipient profile previously generated for this user based on matching of the contact information supplied by the user to the set of contact information stored in the recipient profile; and append the recipient profile with the device identifier contained in the unique QR code transmitted to the computer system from the users mobile device, thereby linking this device identifier—unique to the user's mobile device—with additional contact information (e.g., first and last name, mailing address, phone number, email address) and/or engagement data (e.g., stored in engagement packets) previously recorded for this user in the recipient profile.

The system can therefore link attending of the open-house event by the user to receiving of the ad mail card, thereby enabling the realtor to track engagement of the user—such as immediate actions (e.g., scanning of the QR code printed on the advertisement card) and/or delayed actions (e.g., attending of the open-house event) executed by the user—with content initially advertised to the user in the advertisement card viewed by the user, and thereby attribute these actions to the advertisement card sent by the realtor.

### 5.1.3 User Targeting

In one implementation, the system can leverage this plethora of identifying information compiled for this user—such as the initial set of contact information (e.g., first and last name, mailing address, email address, phone number) provided by the realtor, the device identifier (e.g., the MAC address, the Bluetooth ID) associated with and/or unique to the user's mobile device, additional contact and/or personal information supplied by the user (e.g., at the open-house event), and/or request characteristics—such as first-party data (e.g., time, date, device operating system, device type) received by the computer system in the request sent from the user's mobile device—to continue tracking the user's actions and/or engagement with advertising content (e.g., in the physical world) based on detection of the user's mobile device by a set of transceivers installed at various events and/or locations. Further, the system can leverage detection of the user's mobile device to serve advertising content tailored to this particular user—such as by serving the user an ad for available homes in a particular region containing the user's current home and/or by serving the user a particular deal offered by a car dealership the user has visited—based on historical engagement of this user (e.g., stored in the recipient profile) and/or identifying information for the user contained in the recipient profile.

For example, after attending an open-house event hosted by a realtor—and checking-in via scanning of the unique QR code rendered on the transceiver, as described above—the user may walk by a digital billboard installed on a sidewalk, such as at a bus stop along the sidewalk. The digital billboard can include: a digital display configured to render an ad; and a transceiver affixed to a back surface (e.g., opposite the digital display) of the digital billboard and electrically coupled with the digital display, such that the digital display can render a QR code generated by the transceiver. In this example, in response to the user walking within a threshold distance of the transceiver, the system can: detect presence of the mobile device of the user (e.g., within the threshold distance of the second transceiver); and retrieve a device identifier (e.g., a MAC address) of the mobile device. The system can then generate a unique QR code including: the device identifier (e.g., encrypted within the unique QR code); a location identifier associated with a location of the digital billboard; and a pointer to a generic webpage associated with the realtor.

Then, upon scanning of this unique QR code by the user—via her mobile device—the computer system can: receive a request—from the user's mobile device—including the device identifier (e.g., the MAC address of the mobile device), the location identifier, the pointer, a time, a date, etc.; identify the recipient profile associated with the user based on matching of the device identifier included in the request to the device identifier previously stored in the recipient profile; update the generic webpage—such as based on the known mailing address of the user—to generate a customized instance of the webpage, such as including her name in a header on the customized instance of the webpage and/or by including advertising content related to available homes proximal her mailing address (e.g., within 10 miles); and generate an engagement data packet, in the set of engagement packets, for the user based on the time, the date, and an action executed by the user—such as scanning of this unique QR code rendered on the billboard—representing engagement of the user with content initially presented to the user in an advertisement card mailed to this user by the realtor.

Over time, the system can therefore continue to compile engagement data for the user based on detection of presence of the user's mobile device—via matching of the device identifier retrieved by the transceiver to the device identifier stored in the recipient profile for this user—at various locations and/or based on interactions of the user with QR codes presented to the user at these locations. The system can then leverage this engagement data to: enable tracking of outcomes of ad campaigns at increased resolution by enabling tracking of the users actions in the physical world; and tailor advertising content (e.g., ads, deals, promotions) served to this user over time.

### 6. Variation: New Device Identifier

In one variation, the system can onboard a new user in response to detection of a new device identifier—not associated with a previously-generated recipient profile—by the transceiver. In particular, in this variation, the system—in cooperation with the transceiver—can: detect presence of a mobile device at the transceiver; retrieve a device identifier of the mobile device; access a set of device identifiers, each device identifier, in the set of device identifiers, associated with a particular recipient profile in a set of recipient profiles; and, in response to the set of device identifiers excluding the device identifier, generate a new recipient profile associated with the device identifier of the newly-detected mobile device.

In this variation, the system can associate data (e.g., first-party data) collected at an electronic document (e.g., a webpage)—served to the user's mobile device responsive to the user scanning a particular QR code—with a device identifier collected for the user's mobile device. For example, a transceiver can be installed on a mall directory installed in a shopping mall and configured to render a set of ads—each ad including a QR code—for various shops within the shopping mall on a digital display electrically coupled to the transceiver. In this example, in response to a user approaching the mall directory and scanning a QR code corresponding to an ad for a particular shop, the transceiver can: retrieve a device identifier for this mobile device; and transmit this device identifier to the computer system (e.g., in real-time). The computer system can then: receive this device identifier from the transceiver; receive a request including the QR code scanned by the user; and trigger navigation of the users mobile device to a webpage associated with the shop. The computer system can then: generate a recipient profile for this user including the device identifier, access a set of user and/or device data (e.g., first-party data)—such as a device type, a device operating system, a geographic location, a time of day, etc.—collected at the webpage; and link this set of user and/or device data to the recipient profile.

In the preceding example, in response to the user approaching the mall directory at a later time (e.g., later in the day, several days or weeks later), the transceiver can retrieve the device identifier of the user's mobile device and offload this device identifier to the computer system. In response to the device identifier corresponding to the device identifier stored in the recipient profile, the computer system can trigger the digital display to render an ad—including a QR code—associated with the shop previously selected by the user. The ad can include a call-to-action to scan the QR code, such as: “Scan this QR code to access an exclusive promotion!”; “Scan here to get 10% off your next purchase!”; or “Join our rewards program today!” The system can thus retarget this user with advertising content and/or promotions tailored to this user based on the user's historical engagement and/or interest in this content. Additionally and/or alternatively, in this example, the system can leverage user and/or device data (e.g., first-party data) stored in the recipient profile to further tailor advertising content—such as rendered on the digital display and/or linked to the QR code—served to this user.

Further, in this variation, the system can prompt the user to provide additional user information—such as a name, email address, phone number, mailing address, user preferences (e.g., home, travel, clothing, food, furniture), etc.—for storing in the recipient profile. For example, in response to the user scanning a QR code rendered on a transceiver, the system can trigger the mobile device of the user to navigate to a generic webpage linked to a pointer contained in the QR code. The generic webpage can include: a set of text fields configured to receive inputs from the user; and a call-to-action to enter contact information in the set of text fields in order to receive access to a promotion offered at the retail store. In this example, in response to the user entering contact information in the set of text fields, the system can update the recipient profile to include this contact information supplied by the user. The system can then leverage this additional user information—in combination with the device identifier and/or device data collected by the webpage—to further customize content (e.g., advertising content) served to this user and/or to other users exhibiting similar characteristics to this user.

### 7. Updating the Recipient Profile

Over time, the system can update the recipient profile to include additional data collected for the recipient during subsequent scan events triggered by the recipient. For example, the system can update the recipient profile to include: additional recipient and/or device data for a user, such as including a particular device identifier, additional contact information, etc.; content data representing content—such as including digital and/or printed text and images—presented to the user; engagement data representing user engagement and/or interactions with content digitally (e.g., within an electronic document rendered on the user's mobile device) and/or physically (e.g., within a printed advertisement card) presented to the user; and/or location data representing physical location information and/or online location information collected for the user.

### 7.1 Physical Location Information

In one implementation, the system can leverage the device identifier—corresponding to a particular mobile device affiliated with a user—to track physical locations visited by the user over time.

For example, at a first time, in response to a first scan event—corresponding to scanning of a first barcode (e.g., QR code, 2D barcode) rendered within a display in a first location and scanned by a first mobile device accessed by a first user—the system can: receive a first request, from the first mobile device, specifying the first barcode—including a first location identifier associated with the first location and a first device identifier associated with the first computing device—rendered within the display at the first location; and trigger the first mobile device to navigate to a first webpage—linked to the first barcode (e.g., via a first pointer included in the first barcode)—including a prompt to enter contact information. Then, in response to receiving a first set of contact information—such as a name, email address, phone number, mailing address, etc.—for the first user within the first webpage, the system can: link the first device identifier to a first recipient profile associated with the first user based on the first set of contact information corresponding to contact information stored in the first recipient profile, as described above; and link the first location identifier—associated with the first location—to the first recipient profile. The system can thus link the first location identifier to the recipient profile to associate the first recipient with the first scan event corresponding to scanning of the first barcode rendered within the display at the first location.

Then, at a second time succeeding the first time, in response to a second scan event—corresponding to scanning of a second barcode rendered within a display in a second location and scanned by the first mobile device accessed by the first user—the system can: receive a second request, from the first mobile device, specifying the second barcode—including a second location identifier associated with the second location and the first device identifier—rendered on the display in the second location; and, based on the first device identifier, automatically link the second location identifier—associated with the second location—to the first recipient profile. The system can thus link the second location identifier to the recipient profile to associate the first recipient with the second scan event corresponding to scanning of the second barcode rendered within the display at the second location. Additionally, the system can trigger the first mobile device to navigate to a second webpage linked to the second barcode (e.g., via a second pointer included in the second barcode).

The system can therefore derive physical location data—such as including a timeseries of physical locations (e.g., a geographic location, a particular location type, a particular vendor, a particular event) visited by the user over time—and store this physical location data in the recipient profile generated for this particular user.

For example, in response to a first scan event—corresponding to scanning of a QR code, rendered within a display arranged in a first location, by a mobile device accessed by a user—the system can receive a first request from the mobile device specifying the QR code and including: a first location identifier associated with the first location; and a device identifier associated with the mobile device. Then, in response to the device identifier corresponding to (e.g., matching) a first device identifier linked to a first recipient profile, in a set of recipient profiles, associated with a first recipient, the system can: flag the user as the first recipient and/or flag the mobile device as a first mobile device affiliated with the first recipient; and automatically associate the first scan event with the first recipient. In particular, in this example, the system can generate a first timestamped scan event packet—including a first time value corresponding to the first time and the first location identifier associated with the first location—and store this first timestamped scan event packet in the first recipient profile.

Then, at a second time succeeding the first time, in response to a second scan event—corresponding to scanning of a second QR code rendered within a display arranged in a second location and scanned by the first mobile device accessed by the first recipient—the system can similarly: receive a second request specifying the second QR code and including a second location identifier associated with the second location and the device identifier; flag the user as the first recipient and/or flag the mobile device as the first mobile device affiliated with the first recipient; generate a second timestamped scan event packet—including a second time value corresponding to the second time and the second location identifier associated with the second location—and store this second timestamped scan event packet in the first recipient profile. Over time, the system can repeat this process to generate: a third timestamped scan event packet including a third time value corresponding to a third time and a third location identifier associated with a third location visited by the first recipient; a fourth timestamped scan event packet including a fourth time value corresponding to a fourth time and a fourth location identifier associated with a fourth location visited by the first recipient; etc.

The system can thus derive a timeseries of physical location data for the first recipient based on timestamped scan event packets stored in the first recipient profile. In particular, in the preceding example, the system can derive a timeseries of physical location data including: the first location identifier—associated with the first location—linked to the first time value; the second location identifier—associated with the second location—linked to the second time value; the third location identifier—associated with the third location—linked to the third time value; the fourth location identifier—associated with the fourth location—linked to the fourth time value; etc.

### 7.2 Online Location Information

Additionally or alternatively, in one implementation, the system can derive online location data—such as including a timeseries of online locations (e.g., a webpage, an electronic document, a particular type of online location, an online location associated with a particular sender) visited (e.g., digitally visited) and/or viewed by the user over time—and store this online location data in the recipient profile generated for this particular user.

For example, at a first time, in response to a first scan event—corresponding to scanning of a QR code by a mobile device accessed by a user—the system can receive a first request from the mobile device specifying the QR code and including: a first pointer to a first webpage loaded with a first set of content (e.g., text and/or images); and a device identifier—such as encrypted in the QR code—associated with the mobile device. Then, in response to the device identifier corresponding to (e.g., matching) a first device identifier linked to a first recipient profile, in a set of recipient profiles, associated with a first recipient, the system can: flag the user as the first recipient and/or flag the mobile device as a first mobile device affiliated with the first recipient; and automatically associate the first scan event with the first recipient. In particular, in this example, the system can generate a first timestamped scan event packet—including a first time value corresponding to the first time, the first pointer to the first webpage, and/or a first content identifier associated with the first set of content rendered within the first webpage at the first time—and store this first timestamped scan event packet in the first recipient profile.

Then, at a second time succeeding the first time, in response to a second scan event—corresponding to scanning of a second QR code by the first mobile device accessed by the first recipient—the system can similarly: receive a second request specifying the second QR code and including a second pointer to a second webpage loaded with a second set of content (e.g., text and/or images) and the device identifier; flag the user as the first recipient and/or flag the mobile device as the first mobile device affiliated with the first recipient; generate a second timestamped scan event packet—including a second time value corresponding to the second time, the second pointer to the second webpage, and/or a second content identifier associated with the second set of content rendered within the second webpage at the second time—and store this second timestamped scan event packet in the first recipient profile. Over time, the system can repeat this process to generate: a third timestamped scan event packet including a third time value corresponding to a third time, a third pointer to a third webpage, and/or a third content identifier associated with a third set of content rendered within the third webpage at the third time; a fourth timestamped scan event packet including a fourth time value corresponding to a fourth time, a fourth pointer to a fourth webpage, and/or a fourth content identifier associated with a fourth set of content rendered within the fourth webpage at the fourth time; etc.

The system can thus derive a timeseries of online location data for the first recipient based on timestamped scan event packets stored in the first recipient profile. In particular, in the preceding example, the system can derive a timeseries of online location data including: the first pointer and/or the first content identifier—associated with the first set of content—linked to the first time value; the second pointer and/or the second content identifier—associated with the second set of content—linked to the second time value; the third pointer and/or the third content identifier—associated with the third set of content—linked to the third time value; the fourth pointer and/or the fourth content identifier—associated with the fourth set of content—linked to the fourth time value; etc.

### 7.3 Engagement Data

The system can capture engagement data—representing engagement and/or user interest in content digitally (e.g., within an online electronic document) and/or physically (e.g., within a printed advertisement card) presented to the user—and link this engagement data to the recipient profile generated for this particular user.

In one implementation, the system can collect engagement data for a user interacting with a physical, printed advertisement card mailed to the user. For example, in response to a scan event corresponding to scanning of a QR code—printed on an advertisement card mailed to a recipient—by a mobile device accessed by the recipient, the system can: receive a request for advertising content from the mobile device, the second request specifying a second barcode and a first set of device characteristics corresponding to the first computing device; trigger the mobile device to navigate to an electronic document linked to the QR code and including a set of advertising content associated with the advertisement card; and derive a set of engagement metrics—representing user engagement and/or interest in content presented within the advertisement card—based on the scan event. The system can then link the set of engagement metrics—representing that the user scanned the QR code printed on the advertisement card—to a recipient profile affiliated with the recipient, such as based on a device identifier encrypted in and/or associated with the QR code and linked to the recipient profile.

Additionally or alternatively, in another implementation, the system can collect engagement data for a user interacting with online content served to the user responsive to a scan event. For example, in response to a scan event corresponding to scanning of a QR code—printed on an advertisement card mailed to a recipient—by a mobile device accessed by the recipient, the system can: trigger the mobile device to navigate to an electronic document linked to the QR code and including a set of advertising content associated with the first advertisement card; and derive a set of engagement metrics based on interactions of the recipient with the set of advertising content presented to the recipient within the electronic document. The system can then link the set of engagement metrics to a recipient profile—affiliated with the recipient—based on a device identifier encrypted in and/or associated with the QR code and linked to the recipient profile.

Therefore, for each scan event initiated by the user, the system can capture a set of engagement data and store this engagement data and/or derived engagement metrics in the recipient profile generated for this user. The system can then associate this engagement with a set of content (e.g., advertising content)—such as physical, printed content and/or online content—presented to the user within an advertisement card and/or within an electronic document (e.g., a particular landing page). Furthermore, the system can link this engagement data to a set of location data—representing an online location and/or a physical location of the user—collected for the user responsive to the scan event. For example, in response to a first scan event—corresponding to a QR code printed on an advertisement card mailed to the user—the system can generate a scan event data packet including: a first content identifier representing a first set of content—including text, images, etc.—presented within the advertisement card; a first location identifier linked to a webpage served to the user's mobile device responsive to the first scan event; a first engagement metric (e.g., “highly engaged”, “moderately engaged”, 10%, 95%, “1/10”, “9.5/10”) representing user engagement with advertisement card based on the first scan event; a second content identifier representing a second set of content—including text, images, etc.—presented within the webpage; and a second engagement metric representing user engagement with the webpage based on user interactions—such as clicks, views, etc.—with content within the webpage. The system can then store this first scan event packet in the recipient profile generated for this user. Over time, the system can repeat this process to generate a series of scan event packets—representing user engagement with content presented to the user over time—for this user and update the recipient profile accordingly.

Furthermore, the system can update these scan event packets based on downstream actions executed by the user and associated with previous content presented to the user. In particular, in the preceding example, in response to a second scan event corresponding to a second QR code rendered on a display arranged within a venue—associated with the advertisement card mailed to the recipient and the webpage served to the recipient's mobile device—the system can generate a second scan event data packet including: the first and second content identifiers representing the first and second set of content; a second location identifier linked to the venue; a third engagement metric representing user engagement with the advertisement card and/or the webpage based on the second scan event, such as based on the user visiting the venue associated with the advertisement card and the webpage). The system can then store this second scan event packet in the recipient profile and thus link this downstream action to the initial content served to the user.

### 8. Personalized User Experience

The system can leverage information—including device identifier(s), contact information, first-party data, online location data and/or physical location data, engagement data, etc.—collected for a particular user and/or for a particular mobile device accessed by a user to serve tailored content to this user over time. For example, in response to retrieving a device identifier of a mobile device—located proximal a transceiver installed on a digital billboard—the system can update an advertisement rendered on the billboard based on user data stored in a recipient profile associated with the device identifier, such as based on historical engagement data, locations and/or events the user has previously visited, a home address of the user, an operating system of the user's mobile device, etc. Additionally and/or alternatively, in response to the user scanning a QR code on the billboard, the system can serve the user a customized instance of an electronic document—such as including a particular promotion or a form to register for a particular event—associated with the ad. Additionally or alternatively, the system can generate and/or customize content printed on advertisement cards mailed to the user based on historical engagement data, historical location data, and or user characteristics stored in the recipient profile for this particular user.

### 8.1 Example: User Preferences

In one implementation, the system can leverage historical user data—stored in the recipient profile—to “learn” user preferences for different categories, such as food, clothing, and/or entertainment preferences. The system can then tailor information presented to the user responsive to a scan event at the user's mobile device based on user preferences for a particular relevant category.

In one example, the system can leverage historical food orders and/or food preferences exhibited by a user—such as at a particular restaurant and/or at all restaurants visited by this user—to suggest a tailored list of food items for this user to order when dining at this particular restaurant. In particular, in this example, to access the menu at the restaurant, the user may align her mobile device with a transceiver—located on the table and including a digital display configured to render a dynamic QR code—to “check in” at the restaurant. The transceiver can then retrieve a device identifier of the user's mobile device; generate a unique QR code including the device identifier and a pointer to a digital menu for the restaurant; and render this unique QR code on the digital display. The user may then scan this unique QR code with her mobile device to access the menu. In response to this scan event, the computer system can: receive a request including the device identifier in the QR code; access a first recipient profile, in a set of recipient profiles, corresponding to the user based on the device identifier; and access a set of dining preferences (e.g., preferred price range, favorite types of foods, favorite types of drinks, vegetarian, vegan, gluten-free, dairy-free, previous food orders) stored for this user in the recipient profile. Then, the system can: access the digital menu for the restaurant; remove a first subset of items, including animal byproducts, from the menu in response to the recipient profile specifying a vegan diet; relocate a particular item to a top of the menu in response to the user previously ordering this item; and trigger the user's mobile device to navigate to this instance of the digital menu tailored to the user's dining preferences.

Further, in the preceding example, the system can store payment information for the user directly within the recipient profile, such that the user may enter her selections and complete payment for her order within this customized instance of the digital menu. In particular, in this example, in response to the user selecting a particular food order for purchase, the system can: prompt the user to confirm purchase of the selected food order (e.g., within the customized instance of the digital menu); and, in response to receiving confirmation of purchase from the user, access a payment method stored in the recipient profile and automatically remit payment for the selected food order with the payment method. Alternatively, in response to the recipient profile omitting a stored payment method, the system can: prompt the user provide a payment method for completing purchase of the selected food order; and prompt the user to confirm storing of this payment method for completing future purchases. In response to receiving confirmation from the user, the system can then store this payment method at the recipient profile.

### 9. User Interest

In one implementation, the system can predict user interest in advertising content based on location data—such as including physical and/or online location information—and/or engagement data collected for this user over time and stored in the recipient profile. In particular, the system can: track timeseries physical location data for the user—representing timestamped physical locations (e.g., a geographic location, a particular vendor, a type of vendor or event) visited by the user—based on scan events initiated by the user scanning QR codes via a known mobile device at these physical locations, as described above; track timeseries online location data for the user—representing online locations (e.g., webpages, native applications) viewed by the user on the mobile device—based on the user scanning QR codes linked to these online locations via the mobile device, as described above; and, based on these timeseries physical location data and timeseries online location data, characterize user interest in advertising content. The system can then selectively tailor and/or generate advertising content presented to this user—such as including digital advertising content served to this user responsive to scan events and/or printed advertising content on physical advertisement cards mailed to this user—based on this particular user's interests.

For example, the system can leverage historical location data and/or engagement data collected for a recipient to derive a set of user interests, such as: a particular geographic region frequently visited by the recipient; types of locations (e.g., a restaurant, a shopping center, a park) visited by the recipient; a demographic of locations visited by the recipient; a format, a tone, a theme, and/or context of content viewed by the first recipient and exhibiting high user engagement or interest; etc. In one example, the system derives: a first set of interests for a first recipient, including a first type of home (e.g., a single family home), a first set of neighborhoods (e.g., a suburban neighborhood) a first demographic (e.g., moderate income, family neighborhood), a first set of user keywords including “park,” “beach,” “backyard,” “family,” etc.; and a second set of interests for a second recipient, including a second type of home (e.g., a condo), a second set of neighborhoods (e.g., a city neighborhood), a second demographic (e.g., high income, single, young neighborhood), a second set of keywords including “luxury,” “up-scale,” “patio,” “vibrant,” etc. Then, in response to receiving a request(s) for advertising content—such as from the recipient's mobile device and/or from a real-estate agent initiating a new advertising campaign—corresponding to a particular advertising campaign, the system can: generate a first set of advertising content—including content according to parameters defined by the advertising campaign and associated with the first set of interests—for presenting to the first recipient (e.g., within an ad card and/or within a webpage); and generate a second set of advertising content—including content according to parameters defined by the advertising campaign and associated with the second set of interests—for presenting to the second recipient.

### 9.1 Interest Model

In one variation, the system can derive an interest model configured to predict user interest in content presented to the user based on user characteristics (e.g., user demographic data, location of device, device type, advertisement card data, time of scanning a QR code), user location data, and/or user engagement data (e.g., scanning the QR code, browsing a linked electronic document, engaging with the sender, visiting a location associated with an advertisement card). For example, the system can implement linear regression, artificial intelligence, a convolutional neural network, or other analysis techniques to develop an intent model linking advertising content—including text, images, etc.—previously served to a recipient, engagement data collected for the recipient interacting with this advertising content, location data collected for the recipient, and/or user characteristics (e.g., name, address, age, gender).

The system can then leverage the interest model to predict user interest in different content—such as online content and/or printed content—presented to the user (e.g., within an electronic document, within an advertisement card) and/or to selectively tailor content presented to the user based on engagement data, location data, and/or user data derived for this particular user over time and stored in the recipient profile generated for this user. The system can then leverage this predicted user interest to selectively generate unique (or “custom”) advertising experiences—tailored to this user—for presenting to the user.

For example, over time, the system can: compile a corpus of engagement data representing engagement or interest of the user in physical (e.g., mailed) and/or online content presented to the user in a recipient profile generated for the user; compile a corpus of location information (e.g., online and/or physical location information)—collected for the user responsive to scan events at the user's mobile device and linked to engagement data in the corpus of engagement data—in the recipient profile; extract a corpus of content characteristics—such as including keywords (e.g., words, phrases, descriptors, theme, tone) and/or images—contained and/or associated with content previously presented to the user; and derive an interest model representing user interest in content based on the corpus of engagement data, the corpus of location information, and/or the corpus of content characteristics. The system can similarly repeat this process for each user (or “recipient”) of content to derive and/or represent each user's interest in content presented to the user, and therefore selectively customize and/or generate content for this particular user based on the user's interests.

### 10. Unique Content Generation

In one implementation, the system can automatically generate unique content for presenting to the user—such as within an online environment (e.g., an electronic document) and/or within a printed advertisement card—based on historical user data stored in the recipient profile generated for this user. In particular, the system can: receive a request for content generation, such as for online content generation from a user's mobile device and/or for printed content generation from a sender of advertisement cards; and—based on pre-defined parameters for content, specified by the request, automatically generate a set of content (e.g., advertising content)—including text and/or images—tailored to a recipient of this content.

### 10.1 Content Generator

In one variation, the system can train a content generator configured to: ingest a set of content characteristics or “parameters” (e.g., keywords) defined by a “sender” (e.g., advertiser) of content including physical advertisement cards (e.g., ad mailers) and/or online content; ingest an interest model (e.g., an interest vector) derived for a particular recipient based on historical engagement data, location data, and/or characteristics (e.g., name, mailing address, age, gender) of this particular recipient and stored in the recipient profile; ingest a variability vector configured to modify the interest vector to generate variability; and return a set of content—such as including a heading, a body of text, a set of images, etc.—corresponding to the set of content parameters defined by the sender and predicted to yield high user interest in the set of content. For example, the system can implement adversarial and convolutional neural networks to train the content generator.

In one implementation, in response to a request for content (e.g., text, images)—such as including online, digital content and/or printed, physical content—the system can: receive a set of keywords defined for a particular advertisement and/or advertising campaign—such as for presenting within an online environment and/or within a printed advertisement card mailed to a user—by a particular sender (e.g., advertiser); filter the set of keywords based on predicted user interest—characterized by historical location data and/or engagement data captured for this user—to isolate a subset of keywords, in the set of keywords, most relevant to this user and/or predicted to yield high interest in advertising content associated with this subset of keywords for this user; and automatically generate a set of advertising content for presenting to this particular user, such as within an online environment and/or for printing on a physical, mailed advertisement card.

For example, the system can: receive a request for content for printing on a set of advertisement cards—designating a set of recipients—for an advertising campaign associated with a particular sender; and receive a set of content parameters defined for the set of advertisements cards. Then, for each content parameter, in the set of content parameters, the system can access a set of keywords associated with the content parameter. In particular, in one example, the system can: access a first set of keywords associated with a first content parameter corresponding to a theme of the advertising campaign; access a second set of keywords associated with a second content parameter corresponding to a target audience of the advertising campaign; access a third set of keywords associated with a third content parameter corresponding to a call-to-action for the advertising campaign; etc. The system can thus compile a set of keywords including the first set of keywords, the second set of keywords, the third set of keyword, etc. defined for this particular advertising campaign. Then, for a first advertisement card, in the set of advertisement cards, designating a first recipient, in the set of recipients, the system can:

### 10.2 Physical Mailing Content

In one implementation, the system can leverage historical engagement data stored in the recipient profile in combination with location data to selectively serve and/or generate advertising content for presenting to the user within a printed advertisement card mailed to the user. In particular, in this variation, the system can leverage predicted user interest to tailor and/or automatically generate digital content—including text and images—for presenting to the user within a printed advertisement card mailed to the user by a particular sender.

In this implementation, the system can: receive a sender request specifying a set of content characteristics, such as a tone, a theme, etc.—for generation of content for printing on a set of advertisement cards designating a set of recipients; and, for each recipient, in the set of recipients, automatically generate a unique set of content (e.g., advertising content)—such as including a heading, a body of text, a call-to-action, iconography, images, etc.—corresponding to the set of content characteristics specified by the sender and predicted to achieve high recipient interest in content presented within the unique advertisement card mailed to this recipient.

For example, the system can receive a sender request specifying a set of keywords—including a first theme, a first tone, and a first set of context—and designating a set of recipients. For a first recipient, in the set of recipients, the system can: access a first recipient profile, in a set of recipient profiles, affiliated with the first recipient; retrieve a set of engagement data—representing historical engagement of the user with advertisement cards and/or electronic documents presented to the first recipient responsive to scanning of barcodes (e.g., QR codes) printed on advertisement cards mailed to the first recipient or presented at various locations visited by the first recipient; retrieve a set of location data—representing timeseries locations visited by the first recipient and at which the first recipient scanned a barcode (e.g., rendered within a digital or printed display at the location); and—based on the set of engagement data and the set of location data—filter the set of keywords defined by the sender to isolate a subset of keywords best matched to the first recipient.

In one example, the system can: access an interest model configured to predict user interest in a set of content (e.g., text, images) presented to recipients based on keywords associated with the set of content; and predict a first keyword score, for a first subset of keywords, in the set of keywords, based on the set of engagement data and the set of location data. The system can then repeat this process for each subset of keywords in the set of keywords. For example, the system can: predict a second keyword score, for a second subset of keywords, in the set of keywords, based on the set of engagement data and the set of location data; predict a third keyword score, for a third subset of keywords, in the set of keywords, based on the set of engagement data and the set of location data; etc. Then, in response to the first keyword score exceeding a threshold keyword score—and/or in response to the first keyword score exceeding each other keyword score in the set of keyword scores—the system can select the first subset of keywords for generation of content for a first advertisement card for the first recipient. The system can then leverage the first subset of keywords to automatically generate a first set of content—including a first set of text, a first set of images, etc.—for printing on the first advertisement card designating the first recipient.

Then, for a second recipient, in the set of recipients, the system can: access a second recipient profile, in the set of recipient profiles, affiliated with the second recipient; retrieve a second set of engagement data—representing historical engagement of the second recipient with advertisement cards and/or electronic documents presented to the second recipient responsive to scanning of barcodes (e.g., QR codes) printed on advertisement cards mailed to the second recipient or presented at various locations visited by the second recipient; retrieve a second set of location data—representing timeseries locations visited by the second recipient and at which the second recipient scanned a barcode (e.g., rendered within a digital or printed display at the location); and—based on the second set of engagement data and the second set of location data—filter the set of keywords defined by the sender to isolate a unique subset of keywords best matched to the second recipient. For example, the system can: predict a first keyword score, for a first subset of keywords, in the set of keywords, based on the second set of engagement data and the second set of location data. The system can similarly repeat this process for each subset of keywords in the set of keywords. Then, in response to a second keyword score, for a second subset of keywords, exceeding the threshold keyword score—and/or in response to the second keyword score exceeding each other keyword score in the set of keyword scores—the system can select the second subset of keywords for generation of content for a second advertisement card for the second recipient. The system can then leverage the second subset of keywords to automatically generate a second set of content—including a second set of text, a second set of images, etc.—for printing on the second advertisement card designating the second recipient.

The system can thus repeat this process for each recipient, in the set of recipients, to generate a unique set of content for printing on a unique advertisement card—corresponding to the first theme, first tone, and first set of context specified by the sender—for mailing to the specific recipient.

### 10.3 Online Content Generation

Additionally or alternatively, in another implementation, the system can leverage historical engagement data stored in the recipient profile in combination with historical location data to selectively serve and/or generate digital advertising content for presenting to the user in an online environment. In particular, in this variation, the system can leverage predicted user interest to automatically generate digital content—including text and images—for presenting to the user within the electronic document (e.g., a webpage, a native application)—rendered on the user's mobile device responsive to a scan event—in (near) real time.

In this implementation, in response to a scan event initiated at a mobile device by a recipient—such as via scanning of a barcode printed on an advertisement card mailed to this recipient and/or scanning of a barcode presented within a display arranged at a particular (physical) location—the system can: receive a request for content from the mobile device, the request specifying a barcode associated with the recipient and/or mobile device (e.g., via a device identifier and/or a recipient identifier contained in the barcode) and including a pointer to an electronic document (e.g., a landing page on a website and/or within a native application); access a set of content characteristics—such as a tone, theme, or context—defined for content presented within the electronic document by a sender (e.g., advertiser) affiliated with the electronic document and/or affiliated with the advertisement card or display presenting the barcode; and automatically generate a unique set of content (e.g., advertising content)—such as including a heading, a body of text, a call-to-action, iconography, images, a hyperlink(s), etc.—corresponding to the set of content characteristics specified by the sender and predicted to achieve high recipient interest and/or engagement with content presented within this customized instance of the electronic document presented to the recipient on the recipient's mobile device.

For example, the system can receive a first request for content specifying a first QR code—linked to a first recipient and including a pointer to a first webpage—from the first recipient's mobile device. The system can then: access a set of keywords defined for content rendered within the first webpage, such as including a first set of keywords corresponding to a target tone, a second set of keywords corresponding to a theme of content, and a third set of keywords corresponding to a context of content presented within the first webpage; retrieve a first set of engagement data—representing historical engagement of the first recipient with advertisement cards and/or electronic documents presented to the first recipient responsive to scanning of barcodes (e.g., QR codes) printed on advertisement cards mailed to the first recipient or presented at various locations visited by the first recipient; retrieve a first set of location data—representing timeseries locations visited by the first recipient and at which the first recipient scanned a barcode (e.g., rendered within a digital or printed display at the location); and—based on the first set of engagement data and the first set of location data—filter the set of keywords defined by the sender to isolate a subset of keywords best matched to the first recipient.

In particular, in one example, the system can: access an interest model configured to predict user interest in a set of content (e.g., text, images) presented to recipients based on keywords associated with the set of content; predict a first keyword score, for a first subset of keywords, in the set of keywords, based on the first set of engagement data and the first set of location data; and repeat this process for each subset of keywords, in the set of keywords, to identify a particular subset of keywords predicted to yield high user interest in content presented within the first webpage. In particular, in this example, in response to the first keyword score exceeding a threshold keyword score—and/or in response to the first keyword score exceeding each other keyword score in the set of keyword scores—the system can select the first subset of keywords for generation of content for presenting within a first instance of the first webpage served to the first recipient responsive to the first scan event. The system can then: leverage the first subset of keywords to automatically generate a first set of content—including a first set of text, a first set of images, etc.—for rendering within the first instance of the first webpage, such as in (near) real-time; and trigger the mobile device of the first recipient to navigate to the first instance of the first webpage.

Further, in the preceding example, the system can receive a second request—such as concurrent the first request and/or at an earlier or later time—for content specifying a second QR code linked to a second recipient and including the pointer to the first webpage, the second request received from the second recipient's mobile device. The system can then: retrieve a second set of engagement data—representing historical engagement of the second recipient with advertisement cards and/or electronic documents presented to the second recipient responsive to scanning of barcodes (e.g., QR codes) printed on advertisement cards mailed to the second recipient or presented at various locations visited by the second recipient; retrieve a second set of location data—representing timeseries locations visited by the second recipient and at which the second recipient scanned a barcode (e.g., rendered within a digital or printed display at the location); and predict a second keyword score, for a second subset of keywords, in the set of keywords, based on the second set of engagement data and the second set of location data; and repeat this process for each subset of keywords, in the set of keywords, to identify a particular subset of keywords predicted to yield high user interest in content presented within the first webpage. In particular, in this example, in response to the second keyword score exceeding the threshold keyword score—and/or in response to the second keyword score exceeding each other keyword score in the set of keyword scores—the system can select the second subset of keywords for generation of content for presenting within a second instance of the first webpage served to the second recipient responsive to the second scan event. The system can then: leverage the second subset of keywords to automatically generate a second set of content—including a second set of text, a second set of images, etc.—for rendering within the second instance of the first webpage, such as in (near) real-time; and trigger the second mobile device of the second recipient to navigate to the second instance of the first webpage.

### 10.3.1 Online Content Generation: Current Location

In one variation, the system can leverage historical engagement data and location information stored in the recipient profile—in combination with a current location of the user—to selectively serve digital advertising content to the user responsive to a scan event corresponding to a barcode presented to the user at a particular physical location (e.g., a geographic location, a particular vendor, a particular event).

In particular, in one implementation, in response to a scan event—corresponding to a user scanning a QR code rendered within a display of a device installed at a first location—at a first computing device accessed by the user, the system can: receive a first request—specifying a first barcode including a pointer to a webpage and a location identifier associated with the first location—for advertising content from the first computing device; access a set of keywords defined for advertising content associated with the webpage; and, based on the first (current) location of the user—and/or in combination with historical engagement data and/or location data captured for this particular user—select a subset of keywords, in the set of keywords, predicted to yield high user engagement with advertising content associated with the subset of keywords when presented to the user within the webpage. The system can then: automatically generate a set of advertising content—including text and images—for presenting within a first instance of the webpage based on the subset of keywords; and trigger the first computing device to navigate to the first instance of the webpage for presentation of the set of advertising content to the user—present at the first (physical) location—within the webpage.

In one example, in response to the pointer to the webpage corresponding to a real-estate webpage affiliated with a real-estate agent, the system can tailor and/or generate content rendered within the webpage to include a set of home listings within a threshold distance of the first location of the user. In another example, the system can tailor and/or generate content rendered within the webpage based on a set of location characteristics—such as a type of location (e.g., a city, a suburb, a shopping center, a home), a particular event affiliated with the location (e.g., an open house, a sale or promotion, a vendor fair), a particular vendor associated with the location (e.g., a realtor, a car dealership, a restaurant), location demographics, etc.—associated with the first location, such as based on the location identifier included in the request.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during an initial time period, generating a first advertisement card comprising:
a first set of advertising content associated with a first sender of a first set of advertisement cards comprising the first advertisement card; and
a first barcode, in a set of barcodes, printed on the first advertisement card and linked to a first recipient profile, in a set of recipient profiles, affiliated with a first recipient of the first advertisement card;
during a first time period succeeding the initial time period, in response to a first scan event at a first computing device accessed by the first recipient:
receiving a first request for advertising content from the first computing device, the first request specifying the first barcode;
triggering the first computing device to navigate to a first electronic document linked to the first barcode and comprising a second set of advertising content associated with the first advertisement card;
deriving a first set of engagement metrics based on interactions of the first recipient with content presented to the first recipient within the first electronic document; and
based on the first barcode, associating the first set of engagement metrics with the first recipient profile;
during a second time period succeeding the initial time period, in response to a second scan event at the first computing device:
receiving a second request for advertising content from the first computing device, the second request specifying a second barcode comprising a first location identifier associated with a first location and a first set of device characteristics corresponding to the first computing device; and
based on the first set of device characteristics, linking the first location identifier to the first recipient profile; and
during a third time period succeeding the first time period and the second time period:
receiving a sender request for generation of a second advertisement card associated with the first sender and designating the first recipient;
accessing a set of keywords defined for advertising content affiliated with the first sender;
predicting a first keyword score for a first subset of keywords, in the set of keywords, based on the first set of engagement metrics and the first location identifier, the first keyword score representing a propensity of the first recipient to engage with advertising content associated with the first subset of keywords; and
in response to the first keyword score exceeding a threshold score, automatically generating a third set of advertising content for printing on the second advertisement card based on the first subset of keywords.

2. The method of claim 1:
further comprising, during the second time period, in response to the first scan event:
triggering the first computing device to navigate to a second electronic document linked to the second barcode and comprising a third set of advertising content;
deriving a second set of engagement metrics based on interactions of the first recipient with content presented to the first recipient within the second electronic document; and
based on the first set of device characteristics, associating the second set of engagement metrics with the first recipient profile; and
wherein predicting the keyword score for the first subset of keywords based on the first set of engagement data and the first location comprises predicting the keyword score for the first subset of keywords based on the first set of engagement data, the second set of engagement data, and the first location.

3. The method of claim 1:
wherein receiving the first request specifying the first barcode comprises receiving the first request specifying the first barcode comprising a first pointer to the first electronic document;
wherein receiving the second request specifying the second barcode comprises receiving the second request specifying the second barcode comprising a second pointer to a second electronic document; and
further comprising, during the second time period, in response to the second scan event:
accessing a second set of keywords defined for advertising content affiliated with the second electronic document;
predicting a second keyword score for a second subset of keywords, in the second set of keywords, based on the first set of engagement data and the first location, the second keyword score representing a propensity of the first recipient to engage with advertising content associated with the second subset of keywords; and
in response to the second keyword score exceeding the threshold score:
automatically generating a fourth set of advertising content for presenting to the first recipient within the second electronic document; and
triggering the first computing device to navigate to the second electronic document for presentation of the fourth set of advertising content to the first recipient.

4. The method of claim 1:
further comprising:
during the initial time period, generating a third advertisement card comprising:
the first set of advertising content associated with the first sender; and
a second barcode, in the set of identifiers, printed on the third advertisement card and linked to a second recipient profile, in the set of recipient profiles, affiliated with a second recipient of the third advertisement card; and
during a fourth time period succeeding the initial time period and preceding the third time period, in response to a third scan event at a second computing device accessed by the second recipient:
receiving a third request for advertising content from the second computing device, the third request specifying the second barcode;
triggering the second computing device to navigate to the first electronic document linked to the second barcode and comprising the second set of advertising content associated with the set of advertisement cards;
deriving a second set of engagement metrics based on interactions of the second recipient with content presented to the second recipient within the first electronic document; and
based on the second barcode, associating the second set of engagement metrics with the second recipient profile;
wherein receiving the sender request for generation of the second advertisement card associated comprises receiving the sender request for generation of:
the second advertisement card associated with the first sender and designating the first recipient; and
a fourth advertisement card associated with the first sender and designating the second recipient; and
further comprising, during the third time period:
predicting a second keyword score for a second subset of keywords, in the set of keywords, based on the second set of engagement data, the second keyword score representing a propensity of the second recipient to engage with advertising content associated with the second subset of keywords; and
in response to the second keyword score exceeding the threshold score, automatically generating a fourth set of advertising content for printing on the fourth advertisement card based on the second subset of keywords.

5. The method of claim 4, further comprising:
generating a first print file, in a set of print files, comprising instructions for printing of the second advertisement card comprising the third set of advertising content and a third barcode linked to the first recipient profile;
generating a second print file, in the set of print files, comprising instructions for printing of the fourth advertisement card comprising the fourth set of advertising content and a fourth barcode linked to the second recipient profile; and
transmitting the set of print files to a robotic system configured to print copies of print files to generate a first printed copy of the second advertisement card for mailing to the first recipient and a second printed copy of the fourth advertisement card for mailing to the second recipient.

6. The method of claim 1, during a fourth time period succeeding the first time period and the second time period, in response to a third scan event at the first computing device:
receiving a third request for advertising content from the first computing device, the third request specifying the first barcode printed on the first advertisement card;
accessing a second set of keywords defined for advertising content affiliated with the first electronic document;
predicting a second keyword score for a second subset of keywords, in the second set of keywords, based on the first set of engagement data and the first location, the second keyword score representing a propensity of the first recipient to engage with advertising content associated with the second subset of keywords and presented within the first electronic document; and
in response to the second keyword score exceeding the threshold score:
automatically generating a fourth set of advertising content for presenting to the first recipient within the first electronic document; and
triggering the first computing device to navigate to the first electronic document for presentation of the fourth set of advertising content to the first recipient.

7. The method of claim 1:
wherein receiving the second request specifying the second barcode and the first set of device characteristics corresponding to the first computing device further comprises:
at a transceiver installed at the first location:
retrieving a device identifier of a computing device located within a threshold distance of the transceiver; and
rendering the second barcode within a display of the transceiver, the second barcode comprising the device identifier and a location identifier associated with the first location; and
receiving the second request specifying the second barcode and the first device identifier; and
wherein associating the first location with the first recipient profile based on the first set of device characteristics comprises, in response to the device identifier corresponding to a first device identifier linked to the first recipient profile:
flagging the computing device as the first computing device affiliated with the first recipient; and
linking the location identifier to the first recipient profile.

8. The method of claim 1:
wherein generating the first advertisement card comprising the first barcode linked to the first recipient profile comprises generating the first advertisement card comprising the first barcode linked to the first recipient profile storing a first set of contact information for the first recipient;
wherein receiving the second request specifying the second barcode comprises receiving the second request specifying the second barcode comprising:
a first location identifier associated with the first location;
a second pointer to a second electronic document; and
a device identifier associated with the first computing device;
further comprising, in response to receiving the second request, triggering the first computing device to navigate to the second electronic document comprising a prompt to enter a set of contact information; and
wherein linking the first location identifier to the recipient profile based on the first set of device characteristics comprises, in response to the set of contact information entered within the second electronic document corresponding to the first set of contact information stored in the first recipient profile:
linking the device identifier to the first recipient profile;
generating a first location data packet, in a set of location data packets, comprising a first time value corresponding to the second time period and the first location identifier associated with the first location; and
linking the first location data packet to the first recipient profile.

9. The method of claim 8:
further comprising, during a fourth time period succeeding the second time period and preceding the third time period, in response to a third scan event at the first computing device:
receiving a third request for advertising content from the first computing device, the third request specifying a third barcode comprising:
a second location identifier associated with a second location;
a third pointer to a third electronic document; and
the device identifier associated with the first computing device;
generating a second location data packet, in the set of location data packets, comprising a second time value corresponding to the fourth time period and the second location identifier associated with the second location; and
based on the device identifier, linking the second location data packet to the first recipient profile; and
wherein predicting the first keyword score for the first subset of keywords based on the first set of engagement metrics and the first location identifier comprises predicting the first keyword score for the first subset of keywords based on the first set of engagement metrics and the set of location data packets.

10. The method of claim 9:
wherein generating the first location data packet, in the set of location data packets, comprising the first time value corresponding to the second time period and the first location identifier associated with the first location comprises generating the first location data packet, in the set of location data packets, comprising:
the first time value corresponding to the second time period;
the first location identifier associated with the first location; and
a first set of location characteristics corresponding to the first location;
wherein generating the second location data packet comprising the second time value corresponding to the third time period and the second location identifier associated with the second location comprises generating the second location data packet comprising:
the second time value corresponding to the third time period;
the second location identifier associated with the second location; and
a second set of location characteristics corresponding to the second location;
further comprising:
triggering the first computing device to navigate to the third electronic document based on the third pointer; and
deriving a third set of engagement metrics representing interactions of the first recipient with content presented to the first recipient within the third electronic document; and
wherein predicting the first keyword score based on the first set of engagement metrics and the set of location data packets comprises predicting the first keyword score based on the first set of engagement metrics, the second set of engagement metrics, and the set of location data packets.

11. The method of claim 1:
wherein automatically generating the third set of advertising content for printing on the second advertisement card designating the first recipient comprises generating the third set of advertising content for printing on the second advertisement card designating the first recipient and comprising the third set of advertising content and a third barcode printed on the second advertisement card and linked to the first recipient profile; and
further comprising, during a fourth time period succeeding the third time period, in response to a third scan event at the first computing device:
receiving a third request for advertising content from the first computing device, the third request specifying the third barcode;
triggering the first computing device to navigate to a second electronic document linked to the second barcode and comprising a fourth set of advertising content associated with the second advertisement card;
deriving a second set of engagement metrics based on interactions of the first recipient with content presented to the first recipient within the second electronic document; and
based on the second barcode, associating the second set of engagement metrics with the second recipient profile.

12. The method of claim 1:
wherein automatically generating the third set of advertising content for printing on the second advertisement card designating the first recipient comprises, at a first time during the third time period, generating the third set of advertising content for printing on the second advertisement card designating the first recipient and comprising the third set of advertising content and a third barcode printed on the second advertisement card and linked to the first recipient profile;
further comprising, during the third time period:
at a second time succeeding the first time, receiving confirmation of transmittal of the second advertisement card to the first recipient via mail and initiating a timer for a fixed duration; and
at a third time succeeding the second time, in response to expiration of the fixed duration and in response to absence of a scan event corresponding to the third barcode during the fixed duration, deriving a second set of engagement metrics based on absence of the scan event and associating the second set of engagement metrics with the first recipient profile; and
further comprising, during a fourth time period succeeding the third time period:
receiving a second sender request for generation of a third advertisement card associated with the first sender and designating the first recipient;
accessing a second set of keywords defined for advertising content associated with the second set of advertisement cards;
predicting a second keyword score for a second subset of keywords, in the second set of keywords, based on the first set of engagement data, the first location, and the second set of engagement data, the second keyword score representing a propensity of the first recipient to engage with advertising content associated with the second subset of keywords; and
in response to the first keyword score exceeding a threshold score, automatically generating a fourth set of advertising content for printing on the third advertisement card based on the second subset of keywords.

13. The method of claim 1:
further comprising, during the first time period, in response to receiving the first request for advertising content from the first computing device, deriving a second set of engagement metrics, representing interactions of the first recipient with the first advertisement card, based on the first scan event;
wherein receiving the second request from the first computing device in response to the second scan event comprises:
at a transceiver installed at the first location, retrieving a device identifier of a computing device located within a threshold distance of the transceiver at a first time, the first location comprising a venue associated with the first sender;
in response to the second scan event at a second time:
receiving the second request from the first computing device; and
associating the second scan event with the device identifier based on a duration between the first time and the second time;
wherein associating the first location with the first recipient profile based on the first set of device characteristics comprises, in response to the device identifier corresponding to a first device identifier linked to the first recipient profile:
flagging the computing device as the first computing device affiliated with the first recipient; and
linking the location identifier to the first recipient profile; and
further comprising, deriving a third set of engagement metrics representing engagement of the first recipient with content presented to the first recipient in the first advertisement card and within the first electronic document based on identification of the first recipient at the first venue associated with the first sender.

14. The method of claim 1:
wherein predicting the first keyword score further comprises:
predicting the first keyword score for the first subset of keywords based on the first set of engagement data and the first location; and
predicting a second keyword score for a second subset of keywords, in the set of keywords, based on the second set of engagement data and the first location, the second keyword score representing a propensity of the first recipient to engage with advertising content associated with the second subset of keywords; and
wherein automatically generating the third set of advertising content for printing on the second advertisement card based on the first subset of keywords in response to the first keyword score exceeding the threshold score comprises:
in response to the first keyword score exceeding the threshold score and exceeding the second keyword score, automatically generating the third set of advertising content for printing on the second advertisement card based on the first subset of keywords;
in response to the first keyword score exceeding the threshold score and exceeding the first keyword score, automatically generating a fourth set of advertising content for printing on the second advertisement card based on the second subset of keywords; and
in response to the first keyword score falling below the threshold score and in response to the second keyword score falling below the threshold score, automatically generating a fifth set of advertising content for printing on the second advertisement card based on a third subset of keywords in the set of keywords.

15. The method of claim 1:
wherein predicting the first keyword score for the first subset of keywords based on the first set of engagement data and the first location comprises:
accessing an interest model configured to predict user interest in advertising content based on keywords associated with advertising content presented to users;
predicting user interest in advertising content generated from the first subset of keywords based on the first set of engagement data and the first location; and
calculating the first keyword score based on the first set of engagement data, the first location, and the interest model; and
wherein generating the third set of advertising content for printing on the second advertisement card comprises, at a content generator configured to transform keywords into advertising content comprising a string of text, automatically generating the third set of advertising content for printing on the second advertisement card based on the first subset of keywords.

16. A method comprising:
during a first time period:
at a first transceiver installed in a venue at a first location:
retrieving a device identifier of a mobile device located within a threshold distance of the transceiver; and
rendering a first barcode within a display installed at the first location, the first barcode comprising:
a first pointer to a first electronic document;
a first location identifier linked to the first location; and
the device identifier associated with the mobile device;
in response to a first scan event initiated by the recipient:
receiving a request from the mobile device, the request specifying the first barcode;
triggering the mobile device to navigate to the first electronic document based on the first pointer, the first electronic document comprising a prompt to enter a set of contact information for the first recipient; and
in response to receiving the set of contact information from the first recipient, linking the first location identifier, the device identifier, and the first set of contact information to a first recipient profile, in a set of recipient profiles, associated with the first recipient; and
during a second time period succeeding the first time period:
at a second transceiver installed at a second location:
retrieving the device identifier of the mobile device located within the threshold distance of the second transceiver;
rendering a second barcode within a display installed at the second location, the second barcode comprising:
a second pointer to a second electronic document;
a second location identifier linked to the second location; and
the device identifier;
in response to a second scan event initiated by the first recipient:
receiving a second request from the mobile device, the second request specifying the second barcode;
in response to the device identifier corresponding to the device identifier linked to the first recipient profile:
generating a set of content for presenting to the first recipient within the second electronic document based on the first set of contact information, the first location identifier, and the second location identifier; and
based on the second pointer, triggering the mobile device to navigate to the second electronic document loaded with the set of content.

17. The method of claim 16:
wherein generating the set of content for presenting to the first recipient based on the first set of contact information, the first location identifier, and the second location identifier, comprises:
accessing a first set of keywords defined for content affiliated with the second electronic document;
selecting a first subset of keywords, in the set of keywords, for generation of content within the second electronic document based on the first set of contact information, the first location identifier, and the second location identifier;
at a content generator configured to transform keywords into text content, generating the set of content for presenting to the first recipient based on the first subset of keywords and the first set of contact information;
further comprising:
in response to triggering the mobile device to navigate to the second electronic document:
deriving a set of engagement data representing interactions of the first recipient with the set of content presented within the second electronic document; and
linking the set of engagement data to the first recipient profile; and
during a third time period succeeding the second time period:
receiving a sender request for generation of a first advertisement card associated with the first sender and designating the first recipient;
accessing a second set of keywords defined for content affiliated with the first advertisement card;
selecting a second subset of keywords, in the second set of keywords, for generation of content within the first advertisement card based on the first set of contact information, the first location identifier, the second location identifier, and the set of engagement data; and
at the content generator, generating a second set of content for printing on the first advertisement card based on the second subset of keywords and the first set of contact information.

18. A method comprising:
during an initial time period:
receiving a set of contact information of a recipient designated for receiving an advertisement card comprising advertising content specified by a sender of the advertisement card from the sender;
storing the set of contact information in a recipient profile, in a set of recipient profiles, generated for the recipient; and
linking a first barcode printed on the advertisement card to the recipient profile, the first barcode comprising a pointer to a webpage;
during a first time period succeeding the initial time period, in response to a first scan event initiated by the recipient:
receiving a first request from a mobile device accessed by the recipient, the first request specifying the first barcode;
modifying the webpage to generate a customized instance of the webpage based on the set of contact information stored in the recipient profile;
triggering the mobile device to navigate to the customized instance of the webpage;
accessing a set of device information of the mobile device recorded at the webpage;
generating a first engagement metric representing recipient interactions with threshold advertisement card based on the first scan event; and
storing the set of device information and the first engagement metric in the recipient profile;
during a second time period succeeding the first time period:
at a transceiver installed in a venue associated with the advertisement card:
retrieving a device identifier of a first mobile device located within a threshold distance of the transceiver;
rendering a second barcode on a display of the transceiver, the second barcode comprising a location identifier and the device identifier encrypted within the second barcode; and
in response to a second scan event initiated by the recipient:
receiving a second request from the first mobile device, the second request specifying the second barcode;
triggering the first mobile device to navigate to an electronic document linked to the second barcode and comprising a prompt to enter a second set of contact information within the electronic document;
in response to the second set of contact information corresponding to the first set of contact information stored in the recipient profile:
linking the device identifier to the recipient profile;
generating a second engagement metric based on the second scan event; and
storing the second set of contact information and the second engagement metric in the recipient profile.

19. The method of claim 18, further comprising, during a third time period succeeding the first time period and the second time period:
receiving a sender request for generation of a second advertisement card associated with the sender and designating the first recipient;
accessing a set of keywords defined for the second advertisement card by the sender;
predicting a first keyword score for a first subset of keywords, in the set of keywords, based on the first engagement metric and the second engagement metric, the first keyword score representing a propensity of the recipient to engage with advertising content associated with the first subset of keywords; and
in response to the first keyword score exceeding a threshold score, automatically generating a set of advertising content for printing on the second advertisement card based on the first subset of keywords.

20. The method of claim 18, further comprising, during a third time period succeeding the second time period:
at a second transceiver installed in a second venue:
retrieving a second device identifier of a second mobile device located within a threshold distance of the second transceiver; and
rendering a third barcode on a display of the second transceiver, the third barcode specifying a second location identifier and the second device identifier encrypted within the third barcode; and
in response to a third scan event initiated by the second mobile device:
receiving a third request from the second mobile device, the third request specifying the third barcode;
triggering the second mobile device to navigate to a second electronic document linked to the third barcode and comprising a set of advertising content;
deriving a third engagement metric, in the set of engagement metrics, based on the third scan event at the second venue; and
in response to the second device identifier corresponding to the device identifier stored in the recipient profile, linking the third engagement metric to the recipient profile.
